(19) United States
(12) Patent Application Publication
(10) Pub. No.: US 2024/0425659 A1
(43) Pub. Date: Dec. 26, 2024

(54) THERMOPLASTIC POLYMER FOAMS AND METHODS OF MAKING SAME

(71) Applicant: Moxietec, LLC, Grove City, PA (US)

(72) Inventors: Abolfazl Mohebbi, Mississauga (CA); Olivia Kaori Dubin, Pittsburgh, PA (US); Christopher David Tatters, JR., Slippery Rock, PA (US); Andrew Tempalski, Hookstown, PA (US); Nate Albensi, Meadville, PA (US)

(21) Appl. No.: 18/748,875

(22) Filed: Jun. 20, 2024

Related U.S. Application Data
(60) Provisional application No. 63/509,143, filed on Jun. 20, 2023.

(51) Int. Cl. C08J 9/04; B29C 45/00; B29K 21/00; B29K 75/00; B29K 105/00; B29K 105/04; C08J 9/00

(52) U.S. Cl. CPC C08J 9/04; B29C 45/0001; C08J 9/0004; B29K 2021/003; B29K 2075/00; B29K 2105/0088; B29K 2105/041; B29K 2995/0094; C08J 2205/044; C08J 2375/04

(57) ABSTRACT

A thermoplastic foam article includes a thermoplastic polyurethane composition. The thermoplastic polyurethane composition includes a blowing agent and a nucleating agent. The thermoplastic polyurethane foam article has an average density reduction or porosity of more than 10%.

### REFERENCE TO RELATED APPLICATIONS

This application claims priority from U.S. Provisional Patent Application No. 63/509,143, filed on Jun. 20, 2024, which is incorporated by reference herein in its entirety.

### FIELD OF INVENTION

The present disclosure generally relates to thermoplastic foams. More specifically, the present disclosure relates to injection molding processes and formulations for forming thermoplastic foams with certain preferred cellular structure, physical characteristics, and mechanical properties.

### BACKGROUND

Certain thermoplastic polymers, such as thermoplastic polyurethanes (TPU), thermoplastic elastomers (TPE), and thermoplastic vulcanizate (TPV) exhibit mechanical properties of rubber however, such materials can be processed in an injection molding process similar to typical plastic materials. For example, TPUs are randomly segmented copolymers including hard and soft segments resulted in a two-phase microstructure, which behaves as a “spring and dashpot” mechanism. Such a mechanism results in a unique viscoelastic behavior. The hard segments act as physical crosslinks including a high volume of chain entanglements and perform similar function to chemical crosslinking in rubbers that lead to elastomeric behavior, while the soft segments are above their glass transition temperature at the room temperature and result in a rubber-like behavior. The hard phases are below their glass transition at the room temperature, and play the main role in determining permanent deformation, hysteresis, and high modulus. As a result, TPUs show high elasticity combined with high abrasion resistance resulting in a wide range of applications in aerospace, furniture, and footwear industries for example.

Thermoplastics can be “foamed” by introducing a blowing agent into the polymer matrix while it is melted within an injection molding machine. A foamed thermoplastic typically includes an internal cellular structure. Several parameters including processing settings and formulations control this cellular structural and the resulting mechanical and physical properties of an article formed with a foamed thermoplastic. It is difficult to select formulations and corresponding process parameters to form thermoplastic foams with predictable and desirable properties. Typically, articles made from foamed thermoplastics have inconsistent cellular structure and inconsistent and undesirable mechanical and physical properties. For example, prior art foamed thermoplastic articles can include large internal pockets that cause the article to fail under a load. The structure of prior art thermoplastic foam articles typically includes two phases, a first phase that includes an internal cellular structure and a thick solid “skin” layer at the outside surfaces of the article that does not include any cellular structure.

The methods, systems, and articles disclosure herein describe and illustrate the formulation and processing of thermoplastic foams that result in articles with desirable physical and mechanical properties, which are controlled by a consistent cellular structure throughout the article.

### SUMMARY

Disclosed herein are thermoplastic foam articles and methods of making same. In one example, a thermoplastic polyurethane foam article includes a thermoplastic polyurethane composition. The thermoplastic polyurethane composition includes a blowing agent and a nucleating agent. The thermoplastic polyurethane foam article has an average density reduction of more than 10%. The thermoplastic polyurethane article includes a uniform cellular structure throughout the article including from one surface of the article to all other surfaces of the article.

In another example, a method of forming a thermoplastic polyurethane foam article includes providing a thermoplastic polyurethane composition with a blowing agent and a nucleating agent. The method includes melting the thermoplastic polyurethane composition and forming it into an article with a uniform cellular structure.

### BRIEF DESCRIPTION OF THE DRAWINGS

In the accompanying drawings, structures are illustrated that, together with the detailed description provided below, describe example embodiments of the disclosed systems, methods, and apparatus. Where appropriate, like elements are identified with the same or similar reference numerals. Elements shown as a single component can be replaced with multiple components. Elements shown as multiple components can be replaced with a single component. The drawings may not be to scale. The proportion of certain elements may be exaggerated for the purpose of illustration.

FIG. 1 schematically illustrates the structure of a thermoplastic foam article.

FIG. 2 schematically illustrates the structure of a thermoplastic foam article with ellipsoid shaped cells.

FIG. 3 is an image depicting a cross-section of a thermoplastic foam article formed from a formulation of a blend GPPS and HIPS as a base resin.

FIG. 3A is an enhanced image depicting the cross-section the article of FIG. 3.

FIG. 4 is an image depicting a prior art thermoplastic foam article formed from a formulation using polyolefin as the base resin.

FIG. 5A schematically illustrates an exemplary thermoplastic foam article formed from a cylindrical mold.

FIG. 5B is an exemplary image of a cross-sectioned internal portion of a TPU foam article.

FIGS. 6-8 are cross-sectional images of TPU foam articles formed by the molding conditions shown in the respective figure, where each the TPU formulations includes a blowing agent but not a nucleating agent.

FIG. 9 is a summary of the TPU foam articles depicted in FIGS. 6-8.

FIGS. 10-14 are images of TPU foam articles and/or cross-sectional images of each article formed by the molding conditions shown in the respective figure, where each of the TPU formulations includes both a blowing agent and a nucleating agent.

FIG. 15 is cross-sectional images of TPU foam articles formed with various formulations and molding conditions to control the dimensional stability.

FIGS. 16 and 17 are cross-sectional images of TPU foam articles formed with various formulations and molding conditions to control the flexibility of the article.

FIGS. 18-20 are scanning electronic microscope (SEM) images of TPU foam articles formed with various formulations and molding conditions to control the morphology of the article.

FIGS. 21-24 are charts that depict quantitative analysis results of the SEM image in FIGS. 18-20.

FIG. 25 is an image of an exemplary setup of a compression test for testing TPU foam articles.

FIG. 26 is an exemplary cross-sectional image of a low-density TPU foam article formed by the molding conditions shown in the figure.

FIG. 27 is a graph depicting the averaged compressive stress-strain curves of a low-density TPU foam article.

FIGS. 28-31 are SEM images with cellular structure analysis overlay of horizontal and vertical cross-sectioned samples before and after compression tests of low-density TPU foam articles.

FIGS. 32 and 33 are charts depicting quantitative analysis results of the SEM images in FIGS. 28-31.

FIG. 34 is a chart depicting average values of the morphological analysis results in FIGS. 32 and 33.

FIG. 35 is an exemplary cross-sectional image of a high-density TPU foam article formed by the molding conditions shown in the figure.

FIG. 35 is a graph depicting the averaged compressive stress-strain curves of a high-density TPU foam article.

FIGS. 37-40 are SEM images of horizontal and vertical cross-sectional samples before and after compression tests of high-density TPU foam articles.

FIGS. 41 and 42 are charts depicting quantitative analysis results of the SEM images in FIGS. 37-40.

FIG. 43 is a chart depicting average values of the morphological analysis results for the charts in FIGS. 41 and 42.

### DETAILED DESCRIPTION

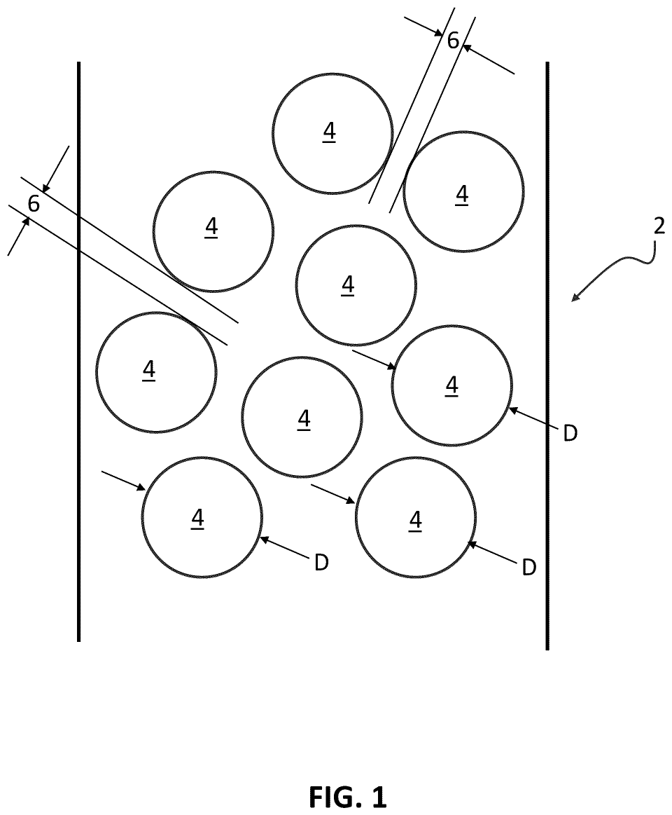

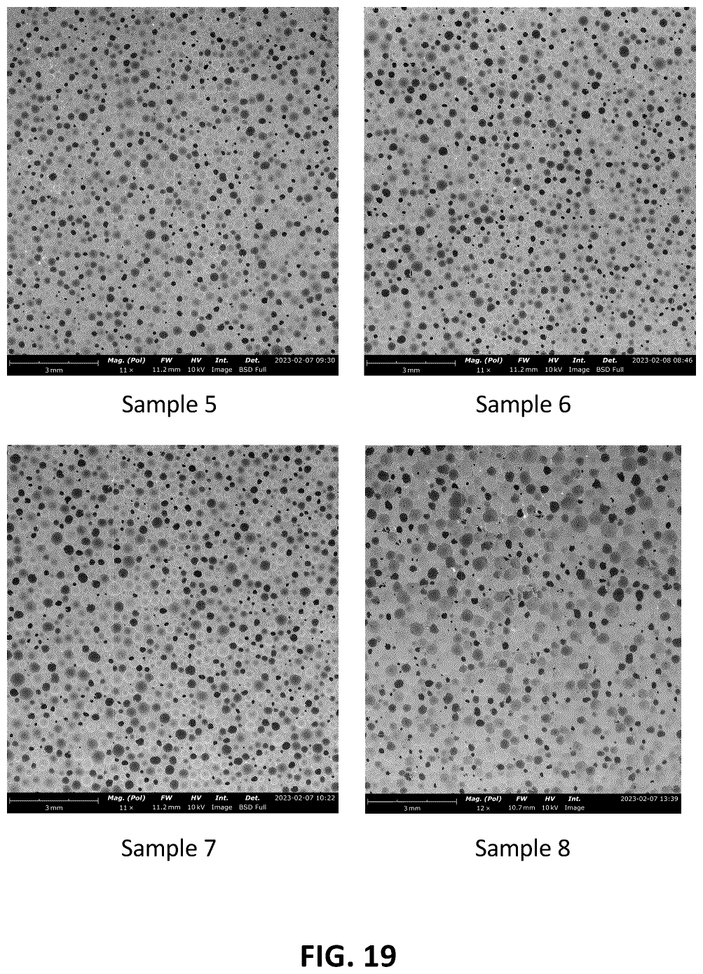

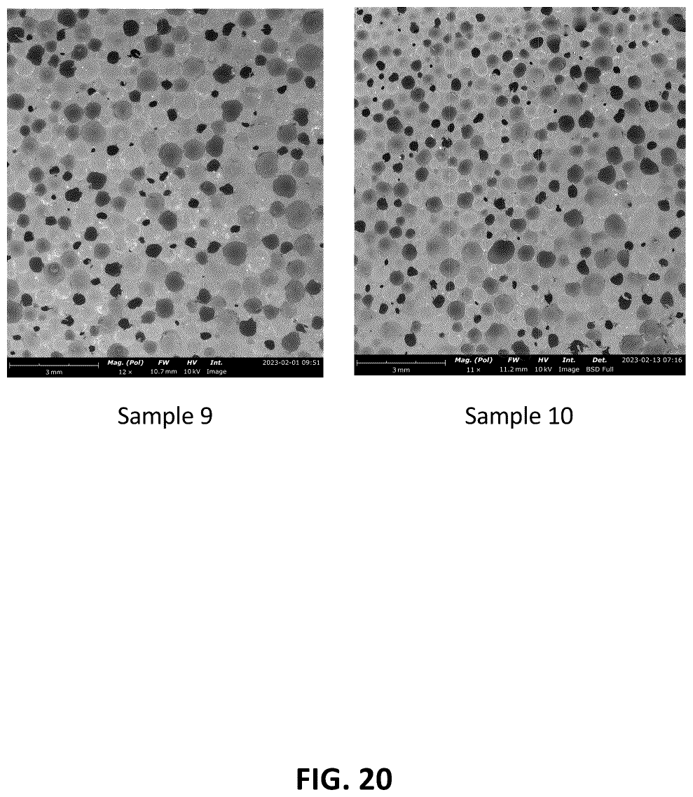

The thermoplastic formulations, thermoplastic foam articles, and methods and systems for making, testing, and characterizing the thermoplastic foam articles disclosed in this document are described in detail by way of examples and with reference to the figures. It will be appreciated that modifications to disclosed and described examples, arrangements, configurations, components, elements, apparatus, methods, materials, etc. can be made and may be desired for a specific application. In this disclosure, any identification of specific techniques, arrangements, method, etc. are either related to a specific example presented or are merely a general description of such a technique, arrangement, method, etc. Identifications of specific details or examples are not intended to be and should not be construed as mandatory or limiting unless specifically designated as such. Selected examples of methods for testing and determining processing parameters for forming TPU foams with certain preferred physical and morphological characteristics and mechanical properties are hereinafter disclosed and described in detail with reference made to FIGS. 1 through 43.

A molten thermoplastic foam suitable for forming a thermoplastic foam article can be made by melting a thermoplastic in an injection molding machine, introducing a blowing agent and/or nucleating agent into the molten polymer within the injection molding machine. The molten thermoplastic foam can then be injected into a mold cavity and the mold cavity is cooled until the thermoplastic foam solidifies to form a thermoplastic foam article. Based on the techniques, methods, and systems described in this disclosure, the physical and mechanical properties of thermoplastic foam articles are controllable by controlling the cellular structures of the thermoplastic foam articles. The cellular structure of thermoplastic foam articles preferably includes cellular uniformity across the thermoplastic foam article. In one embodiment, cellular uniformity comprises consistency in average cell size, cell density, average cell wall thickness, cell shape, circularity (where applicable) and other structural attributes which have direct effects on physical and mechanical properties of thermoplastic foam articles. As will be further described herein, having consistency across one or more structural attributes of the cells can result in a structural uniformity that benefits the mechanical and physical properties of the thermoplastic article.

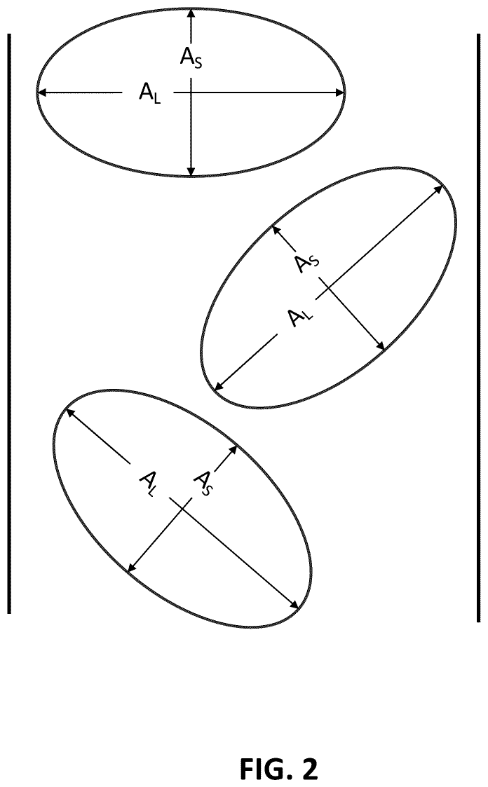

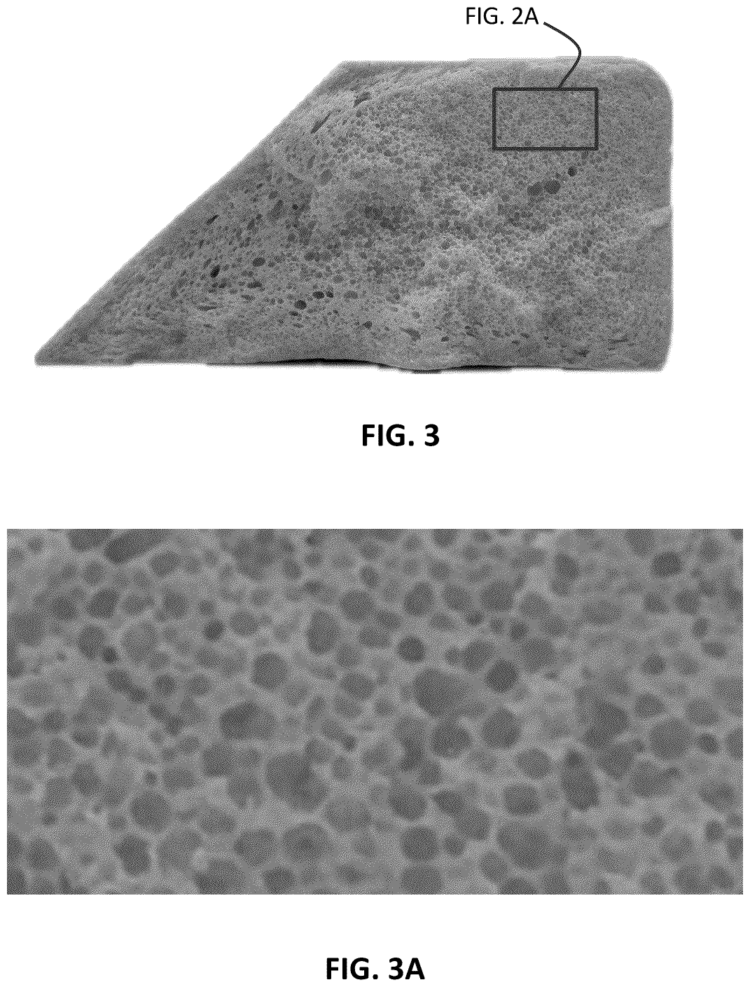

As used herein, the term “bubble” means an air pocket formed in a molten thermoplastic polymer mix in an injection molding machine and/or a mold cavity prior to solidifying into a thermoplastic foam article. As used herein, the term “cell” means an air pocket formed from a bubble in a solidified and final thermoplastic foam article. FIG. 1 is a schematic illustration depicting a cross-section of a thermoplastic foam article identifying structural attributes of the solidified final thermoplastic foam article. The article 2 includes several cells 4, where the solid plastic between cells 4 is referred to as a cell wall 6. The term “cell size” generally refers to the diameter of a cell 4. The cell size of an article is generally assessed by taking a cross-sectional cut through the article and measuring the diameters (D) of cells 4 in two dimensions, as illustrated in FIG. 1. These measurements can then be averaged to determine the average cell size for an article. When a cell is generally spherical, as illustrated in FIG. 1, then the diameter (D) of the cell is generally consistent regardless of how the diameter is measured for each cell, and the average of this diameter measurement for multiple cells can be used to calculate the average cell size for the article. However, the shape of a cell in a thermoplastic foam article can differ based on the thermoplastic used in the formulation. For example, while some thermoplastics result in spherical cells when foamed, other thermoplastics can result in ellipsoid, hexagonal, pentagonal, or general irregular shapes. Thus, using a single diameter measurement or some other singular linear measurement for each cell to determine cell size and average cell size can lead to inconsistent results. Therefore, two measurements can be taken for non-spherical cells. For example, for cells that are generally ellipsoid in shape, as illustrated in FIG. 2, the length of the long axis (A_{L}) and the length of the short axis (A_{S}) can be measured and recorded and these measurements together can quantify cell size and be used to calculate average cell size.

As noted above, under certain circumstances, using diameter of a cell to determine cell size and assess cellular uniformity of a thermoplastic foam article is appropriate when cells are generally spherical. Whether a cell is spherical is determined by the value of a cell's circularity The term “cell circularity” refers to how circular the cell is when viewed two-dimensionally in cross-section, with the value ranging from 0 to 1 with 1 indicating a perfect circle and 0 indicating a line. The term “cell wall thickness” refers to the distance between two cells (i.e., reference number 6 in FIG. 1). The term “cell density” refers to as the number of cells in a cubic centimeter of the thermoplastic foam article. FIG. 3 is an image of a cross-section of a thermoplastic foam article formed from a formulation of a blend of general purpose polystyrene and high impact polystyrene (GPPS/HIPS) as a base resin using processing parameters and techniques described herein. FIG. 3A is an enhanced image of the cross-section the article of FIG. 3 further illustrating the cellular structure of the article.

Based on the intended application of the resulting thermoplastic foam article, the formulation can be selected to optimize the cellular structure specifications of the thermoplastic foam article to control specific properties such as physical, morphological, and mechanical properties. Specifically, by controlling the cell size and cell density of a cellular structure, the mechanical properties of the resulting thermoplastic foam component can be controlled.

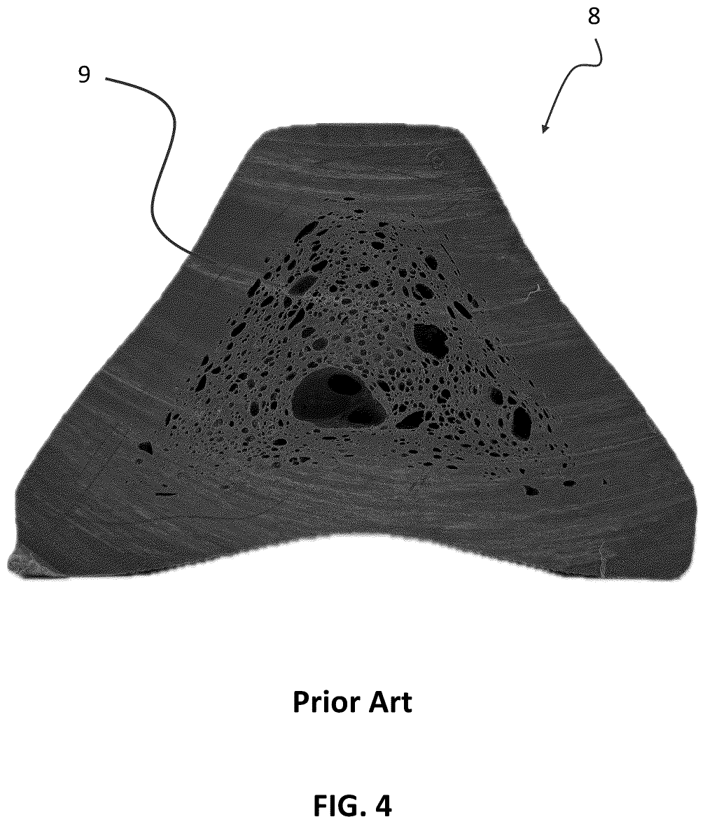

It is challenging to develop thermoplastic foam articles with desired cellular structures that would lead to desired physical, morphological, and mechanical properties. In fact, even at the macroscale level, a thermoplastic foam article, without optimized injection molding formulation and parameters, often exhibits undesirable characteristics, such as sinking and bubble coalescence. Bubble coalescence is a phenomenon where several bubbles in the molten state of the thermoplastic foam come together to form a much larger bubble, which ultimately results in a large open pocket in the thermoplastic foam article (referend to as a “coalesced pocket”). Such coalesced pockets are typically significantly larger than the average cell of the thermoplastic foam. In one embodiment, a coalesced pocket is any pocket that has a linear diameter that is four or more times larger than the average of the largest linear diameter of the remaining cells. In other embodiments, the ratio between the largest diameter of a coalesced pocket and the average of the remaining cells can be more or less than four times depending on the specific thermoplastic foam article being evaluated. Such coalesced pockets can significantly affect the mechanical properties of a thermoplastic article as compared to a thermoplastic foam article with little or no coalesced pockets. FIG. 4 is an image depicting a prior art thermoplastic foam article 8 formed from a formulation using polyolefin as the base resin. As illustrated in FIG. 4, the article 8 includes several coalesced pockets, which will affect the mechanical and physical properties of the article 8. Also of note in the prior art formed article 8 of FIG. 4, there is a significant area along the perimeter 9 of the article 8 that includes no cells and is, in essence, a thick skin layer.

In this disclosure, thermoplastic foam articles are formed by adding a blowing agent and/or a nucleating agent into thermoplastic in a molten state in an injection molding machine. A blowing agent is used to introduce gases into the melt state thermoplastic through a physical and/or chemical system, and the gas molecules form bubbles in the melt state thermoplastic after applying a proper pressure drop rate. As the thermoplastic is cooled in the mold cavity and solidifies into an article, such bubbles result in cells throughout the thermoplastic foam article. A nucleating agent is used to increase the number of bubbles by presenting sites for gas molecules to gather and form bubbles. With proper blending to distribute the nucleating agent, the resulting thermoplastic article has a large number of cells evenly distributed throughout the thermoplastic foam article, which assists in forming a uniform cellular structure throughout the article.

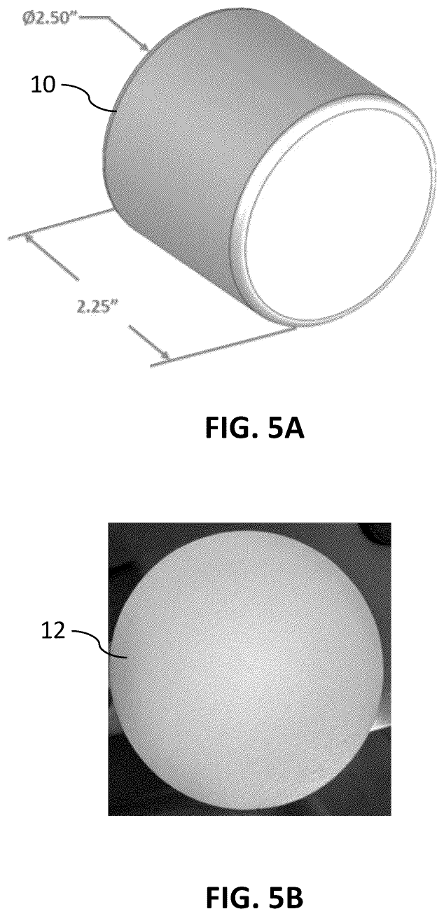

As discussed, the thermoplastic formulation is melted and injected into a mold cavity to form an article 10, such as the article schematically illustrated in FIG. 5A (e.g., cylinder formed from a thermoplastic foamed material). FIG. 5B is an image of an exemplary internal surface 12 take as a cross-sectional of the article 10. This cross-sectional surface 12 is used to illustrate and examine the cellular structure uniformity of the article 10. Formulations and molding conditions (e.g., temperature, injection velocity, shot size, cooling time, etc.) are adjusted to control the qualities of the article. Visual examinations of the article 10 and its cross-section 12 provide assessments of the article's structural properties.

While the formulations are generally described as including thermoplastics, the formulations may specifically comprise a thermoplastic polyurethane (TPU), a thermoplastic elastomer (TPE), a thermoplastic vulcanizate (TPV), or a blend of any of these polymers. For example, thermoplastic polyurethanes may include polyester TPUs, Polyether TPUs, Polycaprolactone TPUs, Aromatic TPUs, Aliphatic TPUs. For example, thermoplastic elastomers may include TPE-E, or TPE-S, a styrenic block copolymer. For example, a thermoplastic vulcanizate may be a mixture of ethylene propylene diene monomer (EPDM) and polypropylene (PP). These thermoplastics and their formulations are usable in any appropriate injection mold machine and mold cavity to form thermoplastic foam articles.

Further, additives in addition to the blowing agent and nucleating agent may be added to the formulations described herein. For example, non-limiting examples of additives may include fibers, pigments, fire retardants, antioxidants, UV absorbers, reinforcement additive, reinforcers, static dissipaters, electrical conductors, thermal conductive materials, graphene, carbon black, any combination or blend of more than one additives, and the like.

The formulations as described when processed using an injection molding process are able to produce structurally uniform thermoplastic articles. That is, when the injection molded article produced as described herein is viewed in cross-section (i.e., a cut is made through the article to reveal its internal structure), the article is characterized by a lack of coalesced pockets and the cell size, cell density, cell wall thickness, cell shape, and/or circularity (where applicable) are structurally uniform, with cells extending from one surface of the article to all other surfaces of the article. With the cells extending from one surface of the article to the other surfaces of the article, the article does not include a “skin” layer at the surface of the article characterized by solid plastic without any cells as seen in the prior art.

With respect to structural uniformity, the shape and size of specific cells can be affected by the proximity of bubbles to the walls of the mold cavity during the transition of a bubble to a cell during the solidification of the molten thermoplastic foam into a thermoplastic foam article. This is to say that the portions of the article that are a distance away from the walls of the mold cavity (i.e., “core section”) are not affected by the walls of the mold cavity during solidification. However, the sections of the article that are proximate to the walls of the mold cavity are affected by the walls of the mold cavity during solidification (i.e., these cells experience a “surface effect”). With respect to the core section, this term is meant to describe largely the interior of the article that is unaffected by the walls of the mold cavity. The shape of the core is not necessarily critical, merely the core is the portion of the article not in close proximity to the internal walls of the mold cavity during solidification of the article and thus are not subject to static forces applied to the molten formulation as it flows and fills the mold cavity under an injection force.

The static forces applied by the walls of the mold cavity to the molten thermoplastic during cooling and solidification of the article can affect the morphology of the article's structure at the mold cavity-article interface as described below. It will be understood that as the molten thermoplastic with blowing agent and/or nucleating agent mixed therein flows through the mold cavity, for molten thermoplastic in the core section there are no static forces from the mold cavity walls applied to the forming bubbles, only the dynamic and generally equal forces of the molten plastic surrounding the bubble. As gases gather from all directions to interact with a nucleating site or existing bubble, a bubble can grow uniformly prior to solidification into a cell. Thus, the cells in the core section are more likely to share a common size and uniform shape as other cells in the core section. However, for molten thermoplastic that flows proximate to the walls of the mold cavity, the walls themselves apply a static force to the forming bubbles. Thus, gas molecules cannot engage with a nucleating site or existing bubble on the side facing the mold cavity wall. The static force has the effect of altering the aspect ratio of the bubble which ultimately results in a more oblong or oval shaped cell. Additionally, less gas molecules interact with the growing bubble. Thus, the bubbles on average will not be as large nor as uniform in shape as those in the core section of the article.

Depending on the dimensions of the article, the surface effect can have either a significant or negligible effect on the statistics of the cell uniformity. Namely, the smaller a dimension of the article (measured surface to surface, such as, for example, a thickness of the article), the more pronounced the effect of the cells that are subject to the surface effect have on the overall statistical calculations of the cellular structure of the article. For example, for an article that has a thickness that is 3.2 mm, the surface effect can significantly skew the statistics regarding average cell size, while an article that is a cube with all three dimensions of 50 mm, the surface effect will have a negligible effect on the statistics regarding average cell size.

In one embodiment, the terms “structural uniformity” and “structurally uniform” as used herein mean that a certain percentage of the cells in a thermoplastic foam article are within a certain percentage of the average cell size of the article as a whole. However, the specific percentage depends on the prominence of the surface effect. For example, for a TPU foamed article where the surface effect is small or negligible, structural uniformity means that about 75% of cells are within 75% of the average cell size for the article. In another example, for a TPU foam article where the surface effect is large, structural uniformity means that about 50% of cells are within 75% of the average cell size for the article. In any TPU foam article, the structural uniformity of the core section means that about 75% of cells in the core section are within 75% of the average cell size in the core section. As a general guideline, if all dimensions of an article are 50 mm or larger, the surface effect is considered small. In other embodiments, structural uniformity additionally means that cell density throughout a TPU foam article does not deviate by more than about 25%; and/or for the TPU foam article is described, about 75% of cells in an article have a wall thickness that is within 75% of the average wall thickness throughout the article. In another embodiment, for thermoplastic foam articles with generally spherical cells, structural uniformity means that the circularity of 75% of the cells of an article are within the range of 0.900 to 1.00. The parameters for structural uniformity are exemplary, and it will be understood upon reading this disclosure that other parameters can be set to establish structural uniformity based on the specific details and circumstances of formulations, processes, and resulting thermoplastic articles. The underlying principle is that the cellular structure is uniform such that desirable mechanical and physical properties are achieved.

As noted above, in some embodiments, the articles produced by the inventive methods described herein are characterized by their uniform structure. In particular, in one embodiment, what is meant by uniform structure is that the article contains cells from one exterior surface thought the article to all other exterior surfaces. That is, the very edge of the exterior surface, too, contains a cellular structure including cells. However, as noted previously, due to the forces exerted on the article during solidification from the interior walls of the mold cavity, the cells found adjacent to the mold cavity walls and forming the exterior surface of the article are necessarily subjected to forces that are not found in the interior core of the article. Thus, while the uniform structure in fact provides a consistent cellular structure throughout the article, the cells found at or near the edge may differ in shape, density, or size from the cells found in the core portion of the article. Nevertheless, these differences in cellular structure at the exterior surface of the article do not detract from the overall performance of the article and additionally, provided a small surface effect, meet the definition in which about 75% of cells of the entire article are within 75% of the average cell size. The differences in shape, density, or size of the cells found proximate to the exterior surface of the article are not in fact a skin, since they are substantially similar to the cells in the core section of the article, but necessarily subject to different physical forces due to the immediate contact with the walls of the mold cavity as described above.

Thus, as described above, articles, even taking into account the surface effect, provide a remarkably uniform structure when produced according to the inventive methods and can often be described as about 75% of cells are within 75% of the average cell size. As previously noted, such a descriptor of the article uniformity may vary with the thickness of the article. That is, an article with a thickness of 3.2 mm has necessarily different considerations than one that is 25 mm or 250 mm thick. For the case of an article with a maximum thickness of 3.2 mm, structural uniformity may be better defined as about 50% of cells are within 75% of the average cell size. For an article with a maximum thickness of 25 mm, structural uniformity may be better defined as about between 50% and 75% of cells are within 75% of the average cell size of the article. It will be understood that when the thickness of an article is on the order of a few millimeters as opposed to the order of tens or hundreds of millimeters, the surface effect will have a more prominent statistical impact on cell properties, and thus, lower the percentage of cells that are within 75% of the average cell size.

Further, for any articles having a uniform structure and produced according to the inventive methods described here, regardless of thickness, may be described as having between about 50% and 75% of cells are within 75% of the average cell size, or between about 60% and 75% of cells are within 75% of the average cell size, or any single numerical value within that range, for example about 62.5% of cells are within 75% of the average cell size. Structural uniformity may also be described in that the cell density of any single section of the article does not vary more than about 25% from any other section of the article.

The formulations described herein are characterized by uniformity in cell size, cell density, cell wall thickness, and where appliable, circularity regardless of amount of cells in total. That is, the methods described herein provide for a structurally uniform article whether the weight reduction is in the range of about 5% to about 80%. That is, distribution of cells is uniform throughout article regardless of the absolute amount of cells in the article. According to some embodiments the range in weight reduction can be some number between the range of 5% and 80% such as 62%, or any sub-range found within 5% and 80%, such as 5% to 20% or 65% to 80%. That is, the embodiments describe useful methods for producing a wide variety of products all characterized by the structurally uniformity of articles produced by the method as charactered herein.

This structural uniformity of the articles produced by the formulations and methods disclosed herein provide for consistent properties within a single article and across multiple articles with respect to rigidity or compressibility, density throughout the entire article because the method greatly reduces the possibility of coalesced pockets and provides consistent and uniform cell distribution throughout the entire molded article. Cell size, cell density, and cell wall thickness all work together cooperatively to provide the desired characteristics of the article and the uniformity of that structure throughout the entire article is an advantage of the methods described herein.

In one embodiment, the injection molding machine includes a melt zone for combining ingredients and a hopper for storing ingredients and delivering ingredients to the melt zone. The injection molding machine can be arranged to deliver the thermoplastic polymer, blowing agent, and/or nucleating agent simultaneously to the melt zone of the injection molding machine. Of course, simultaneously permits for slight variations in timing as long as the blowing agent and nucleating agent are added and thoroughly mixed with the thermoplastic polymer prior to the thermoplastic polymer reaching a temperature in which 100% of the thermoplastic polymer is melted. Such a process results in a generally homogeneous state for the ingredients prior to injecting the formulation into a mold cavity to form an article. In some embodiments, the injection molding machine also includes multiple hoppers for storage separately but also near simultaneous delivery of different mixture components, e.g. the thermoplastic polymer, blowing agent, to the melt zone of the injection molding machine. Other ingredients injected into the melt zone by the injection molding machine includes gases and liquid foaming agents. In one embodiment, the injection into them molding machine of gases and/or liquid foaming agents may occur in a site other than the melt zone, or alternatively in the melt zone and an additional site.

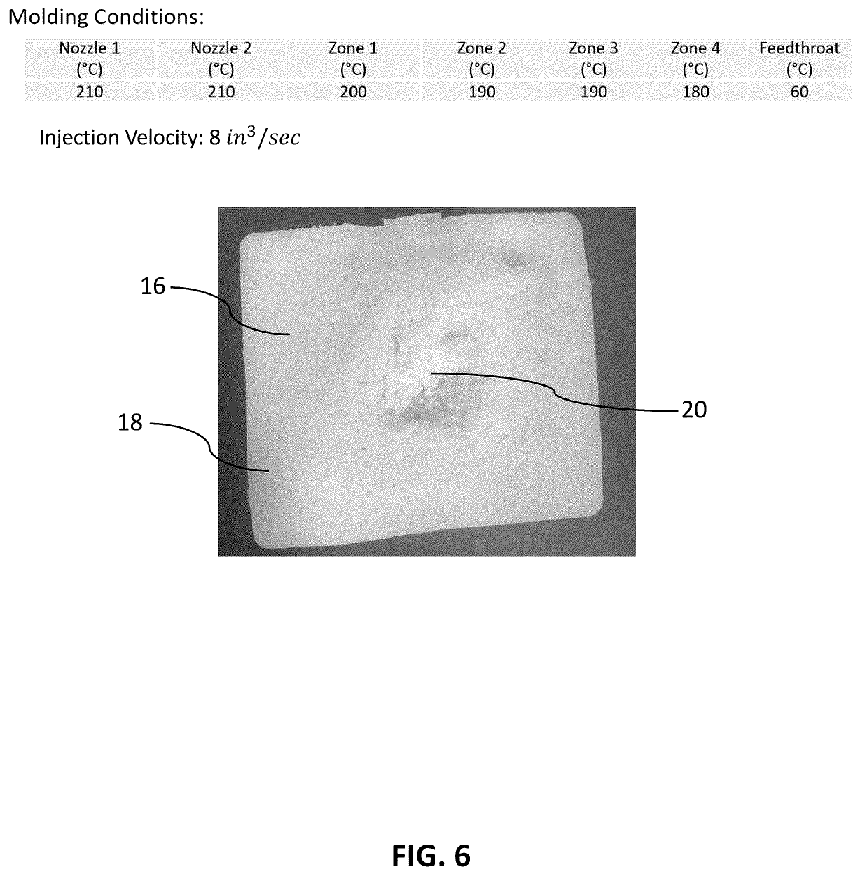

One of the benefits of making articles from thermoplastic foams is to reduce the weight of the article. The following describes a number of exemplary TPU foamed articles along with analysis of cross-sectional images and an analysis of density reduction. In the examples shown in FIGS. 6-8, the TPU foam articles are made from molten TPU with a blowing agent ranging from about 0.01% by weight (wt. %) to about 2.5 wt. % (no nucleating agent is present in these examples) with the ingredients melted and mixed within an injection molding machine. The corresponding molding conditions are also shown in each figure. For example, the TPU formulation is fed into an injection molding machine through a feed-throat, flows through four different temperature zones (e.g., moving downstream from zone 4 to zone 3 to zone 2 and to zone 1) where the TPU formulation is injected into a mold cavity through a region of the nozzle (e.g., moving downstream from nozzle 2 to nozzle 1). The temperature is controlled and varied at the various stages or regions of the injection molding machine. FIGS. 6-8 illustrate the effect of blowing agent concentration on cellular structure.

FIG. 6 depicts an image of an exemplary article 16 in cross-section. The TPU formulation for the article 16 uses a moderate amount of blowing agent, and the article 16 exhibits some shrinkage in the center of the article 16. The article 16 is slightly yellow, which may be attributed to the phase separation. The cellular structure near the surface 18 (as opposed to the core portion 20) appears to be uniform.

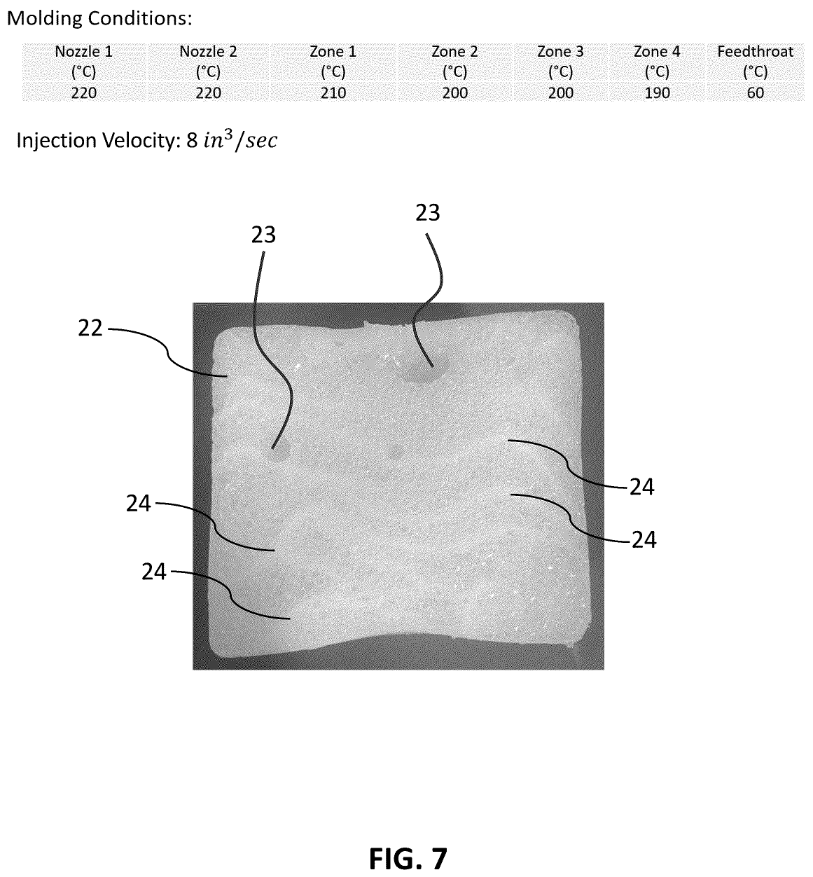

FIG. 7 depicts an image of another exemplary article 22 in cross-section. The TPU formulation for the article 22 uses a relatively low about of blowing agent. The article 22 exhibits a relatively uniform cellular structure apart from a couple occurrences of coalesced pockets 23. The article 22 shows slightly less signs of phase separation, which may be attributed to the excess blowing agent content or residence time. Weld lines 24 from merging flow fronts appear to have a finer and more condensed cellular structure.

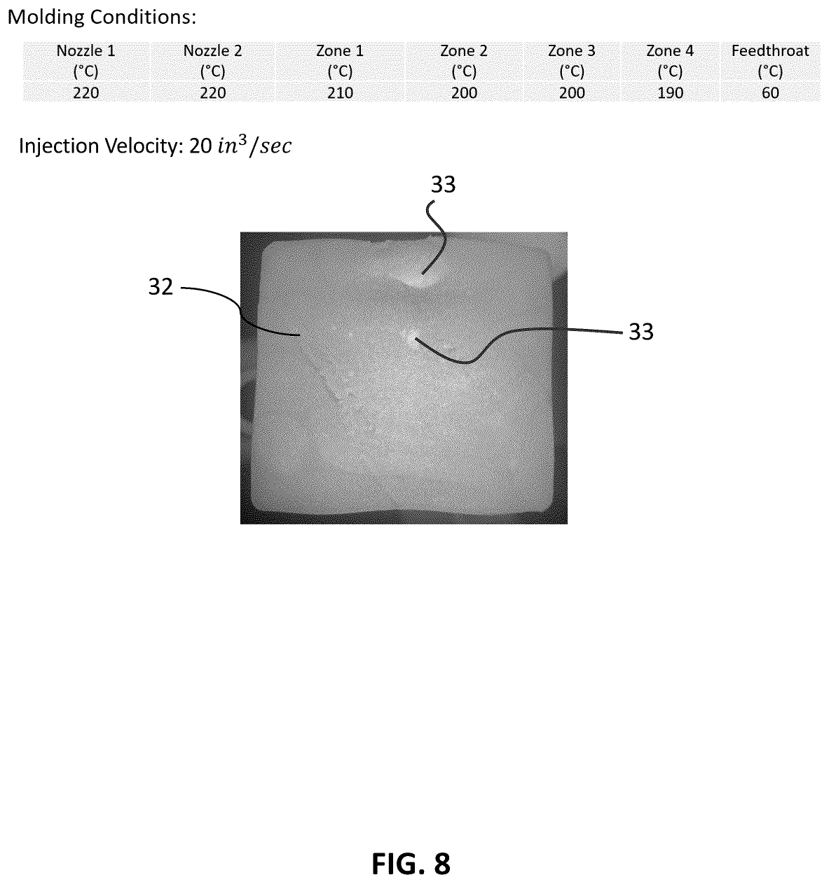

FIG. 8 depicts an image of another exemplary article 32 in cross-section. The TPU formulation for the article 32 uses a moderate amount of blowing agent. The article 32 exhibits a relatively uniform cellular structure apart from a couple of coalesced pockets 33. The article 32 shows a low level of phase separation, which may be attributed to the excess blowing agent content, residence time, or moisture content. The article 32 does exhibits somewhat poor dimensional stability and may require a longer cooling time.

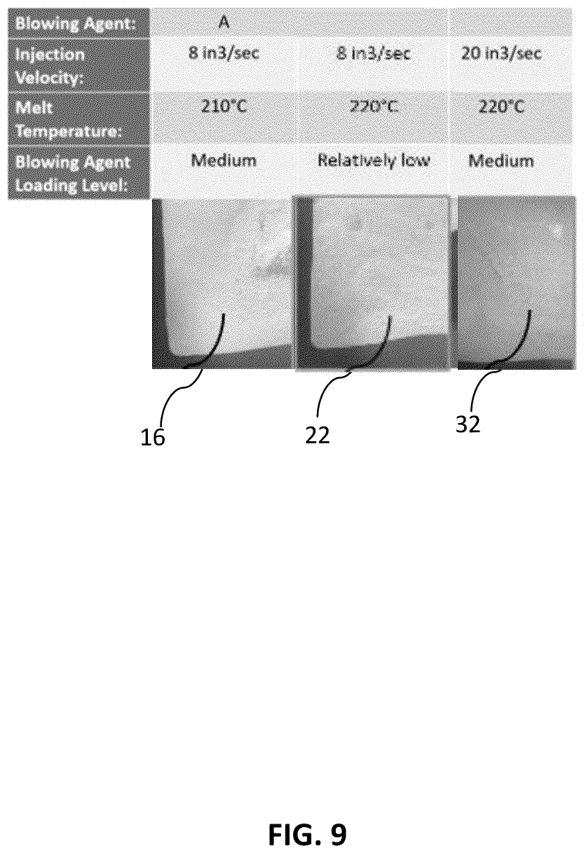

FIG. 9 depicts a summary of the articles 16, 22, and 32 along with the respective molding conditions. The variations in the formulations and the molding conditions have significant effects on the appearance and the dimensional stability of the TPU foam articles.

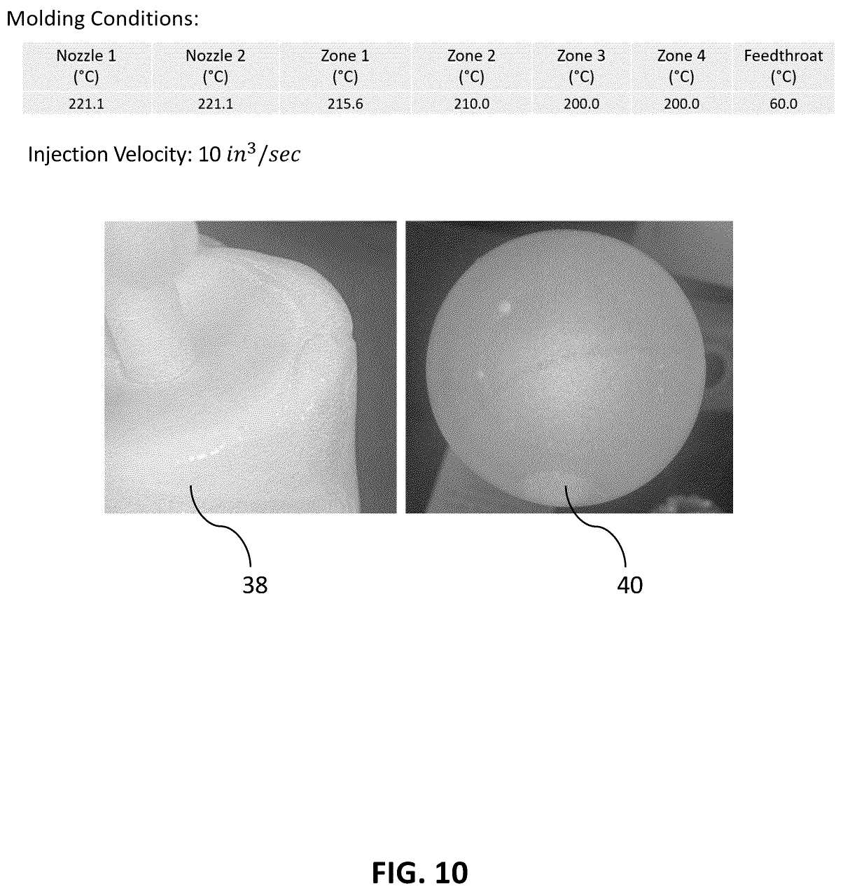

In the articles illustrated in FIGS. 10-14, the TPU foam articles are formed by introducing a nucleating agent at about 0.01 wt. % to about 2 wt. % in addition to the blowing agent at about 0.01 wt. % to about 2.5 wt. % into the molten TPU within an injection molding machine. The corresponding molding conditions are also shown in each figure. These articles illustrate the effect of using both a blowing agent and a nucleating agent (as compared to the articles of FIGS. 6-8 that only have blowing agents).

FIG. 10 depicts an image of another exemplary article 38 with an image of the cross-sectional surface 40 of an article formed with the molding conditions shown in the figure. The articles 38, 40 exhibit a uniform cellular structure apart from a couple coalesced pockets. The article 38 does not fill out all corners of the mold despite being overly puffy.

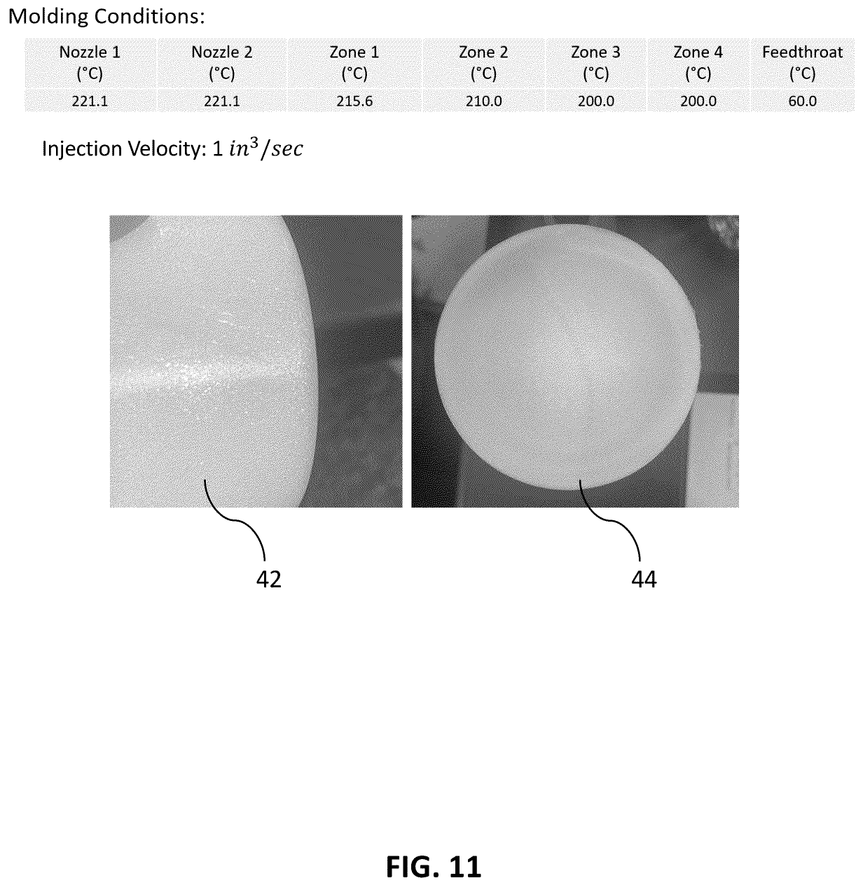

FIG. 11 depicts an image of another exemplary article 42 with an image of the cross-sectional surface 44 of an article formed with the molding conditions shown in the figure. The articles 42, 44 exhibit a uniform cellular structure. The surface finish qualities of the articles 42, 44 are excellent. Signs of puffiness and some degrees of sinking hinder the dimensional stability.

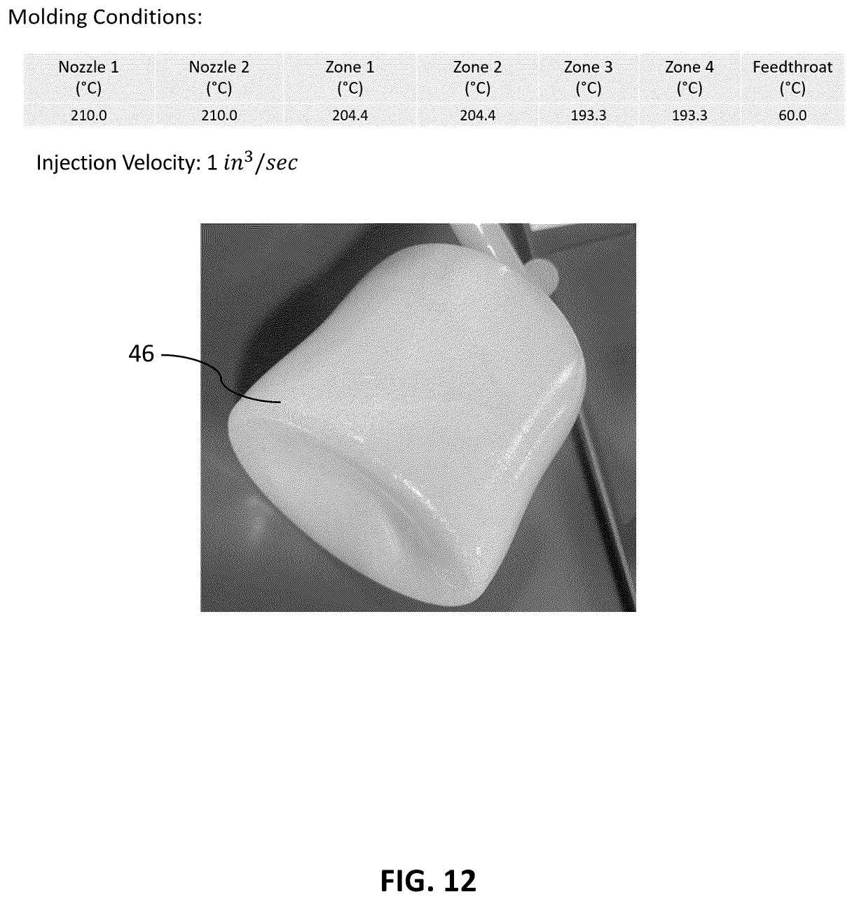

FIG. 12 depicts an image of another exemplary article 46 formed with the molding conditions shown in the figure. The article 46 exhibits a uniform cellular structure. The surface finish qualities are excellent. However, the density reduction is negatively affected by a lower melt temperature and the article shows signs of sinkage (e.g., poor dimensional stability).

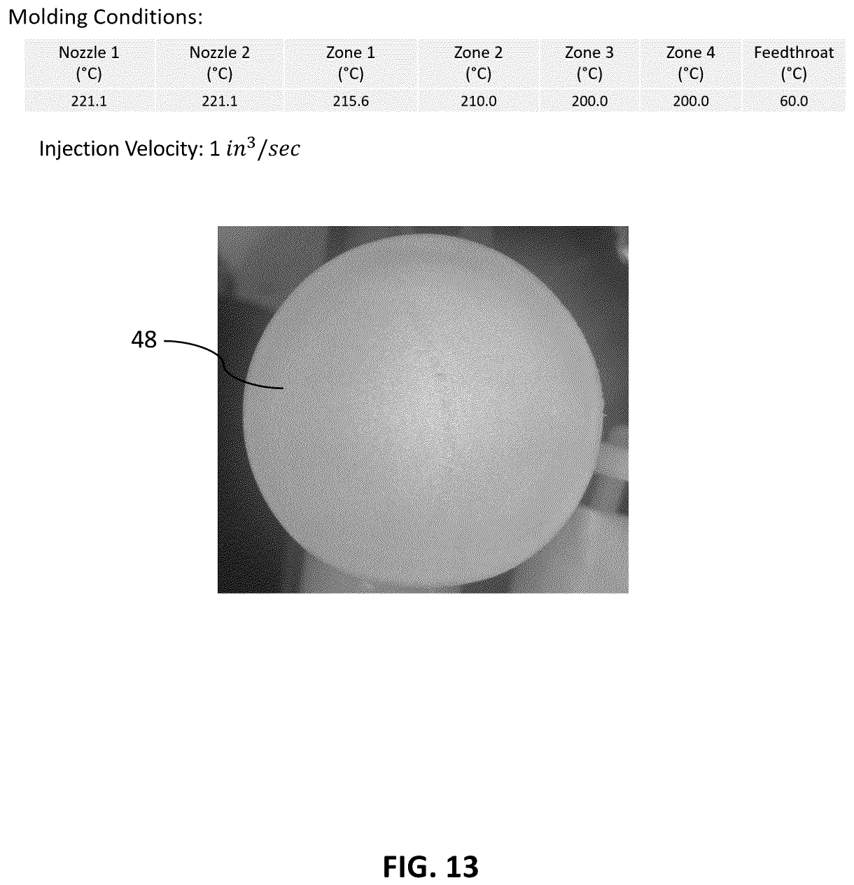

FIG. 13 depicts an image of another exemplary article 48 in cross-section formed with the molding conditions shown in the figure. The article 48 exhibits a uniform cellular structure. The surface finish qualities are excellent. However, signs of puffiness and some degree of sinking hinder the dimensional stability.

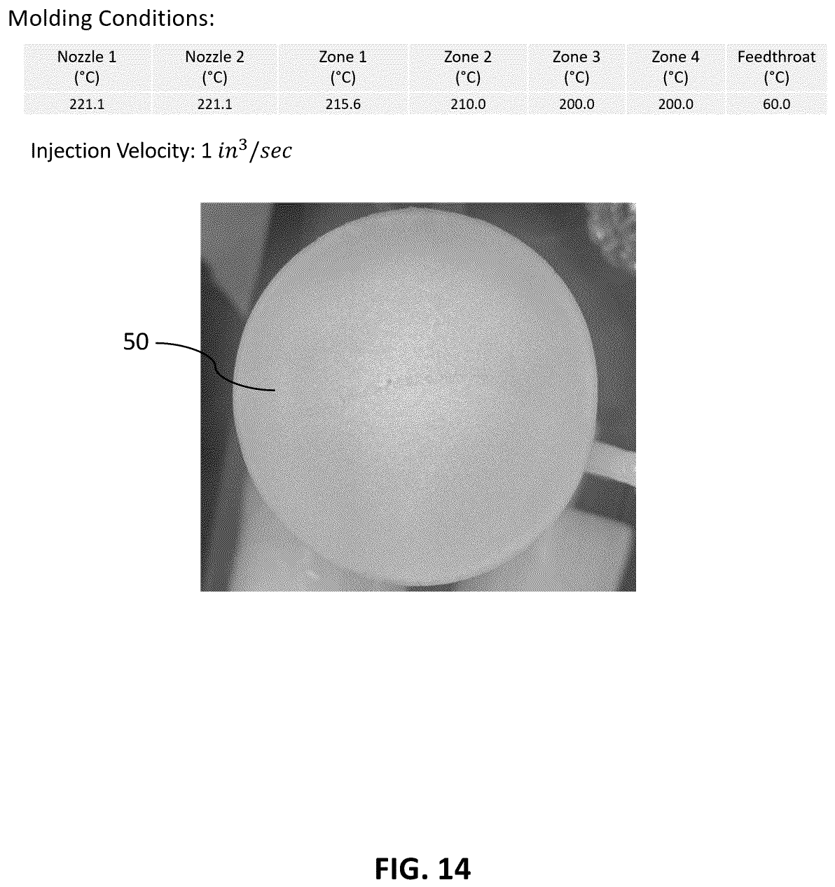

FIG. 14 depicts an image of another exemplary article 50 in cross-section formed with the molding conditions shown in the figure. The article 48 exhibits a uniform cellular structure. The surface finish qualities are excellent. However, signs of puffiness and some degree of sinking hinder the dimensional stability.

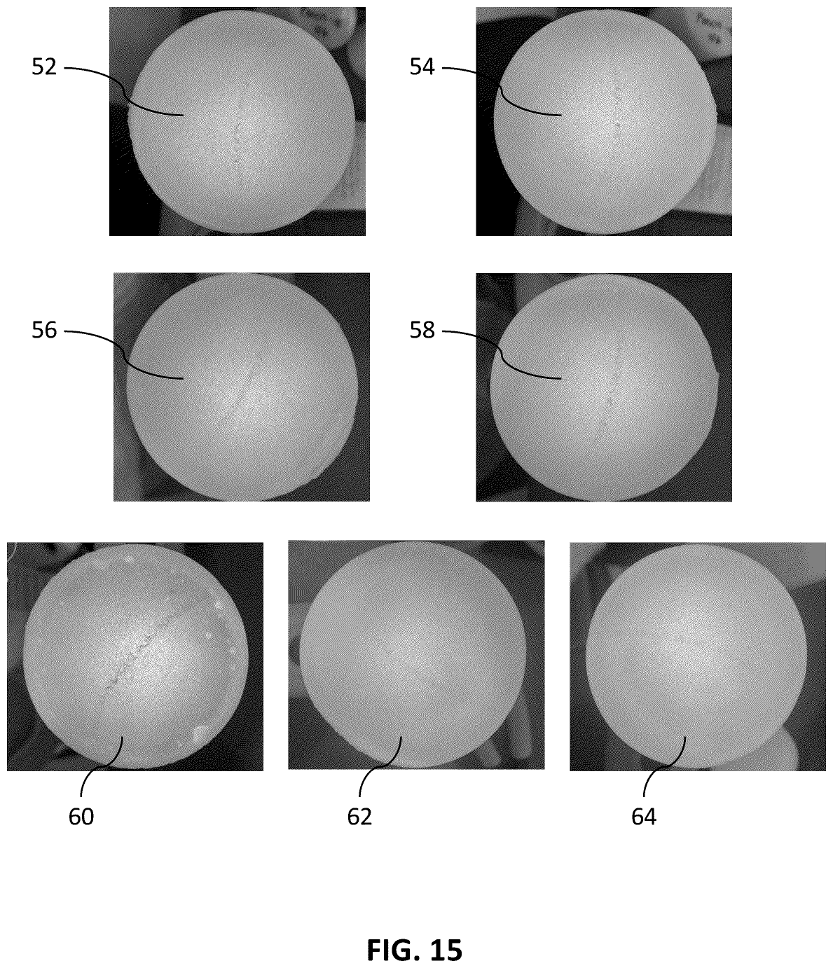

Based on the experimental results, as the amount of nucleating agent is increased, and as the cooling time is increased, the dimensional stability is improved, and as the amount of blowing agent is increased, the density reduction is improved. FIG. 15 is a series of images of cross-sections of articles 52, 54, 56, 58, 60, 62, and 64. All articles 52, 54, 56, 58, 60, 62, and 64 were prepared with the molding conditions of the temperatures at 60° C. at the feed-throat, 200° C. at zone 4, 200° C. at zone 3, 210° C. at zone 2, 215.6° C. at zone one, 221.1° C. at nozzle 2, and 221.1° C. at nozzle 1, and the injection velocity is 1 cubic inch per second (in³/sec).

Article 52 is prepared with a shot size of 18 cubic inch (in³) and cooling time of 220 seconds. The surface finish is excellent with a uniform cellular structure. However, there are signs of puffiness indicating dimensional instability.

Article 54 is prepared with a shot size of 17.5 in³ and cooling time of 300 seconds. The article 54 has a uniform cellular structure, excellent surface finish qualities, and excellent dimensional stability.

Article 56 is prepared with a shot size of 17.5 in³ and cooling time of 300 seconds. The article 56 exhibits a uniform cellular structure, excellent surface finish qualities are excellent, and excellent dimensional stability.

Article 58 is prepared with a shot size of 17 in³ and cooling time of 300 seconds. The article 58 exhibits a uniform cellular structure, excellent surface finish qualities are excellent, and excellent dimensional stability.

Article 60 is prepared with a shot size of 16 in³ and cooling time of 300 seconds. The article 60 exhibits a uniform cellular structure, excellent surface finish qualities are excellent, and excellent dimensional stability.

Article 62 is prepared with a shot size of 18.5 in³ and cooling time of 220 seconds. The article 62 exhibits excellent surface finish qualities and a uniform cellular structure. However, there are signs of inconsistently flat indicating dimensional instability.

Article 64 is prepared with a shot size of 19.5 in³ and cooling time of 300 seconds. The article 64 exhibits excellent surface finish qualities and a uniform cellular structure. However, there are signs of sinking indicating dimensional instability.

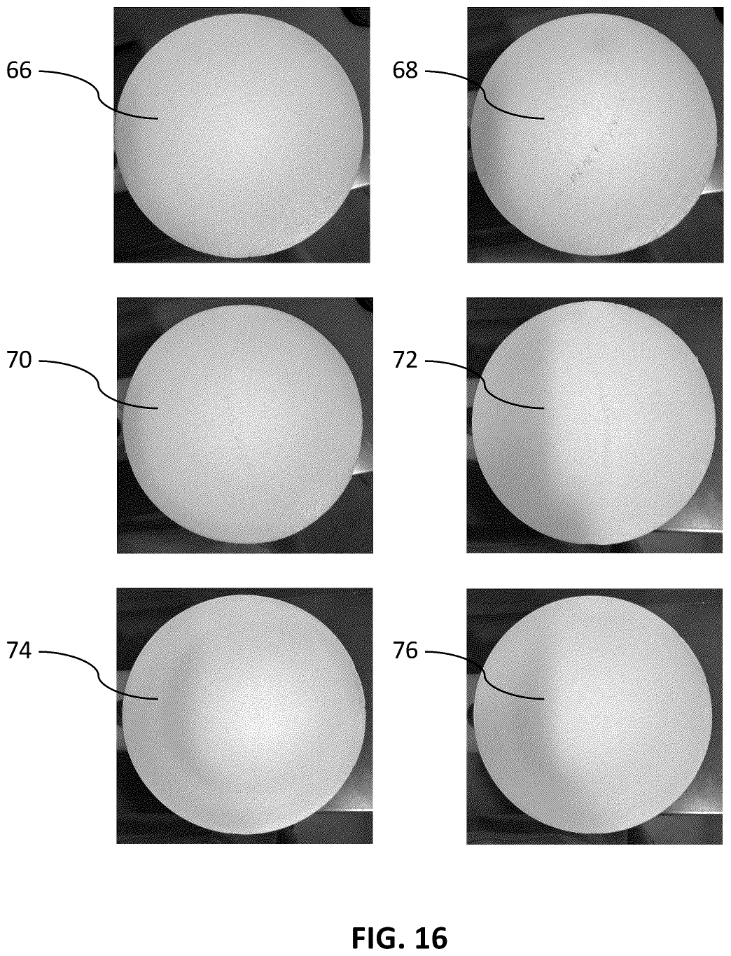

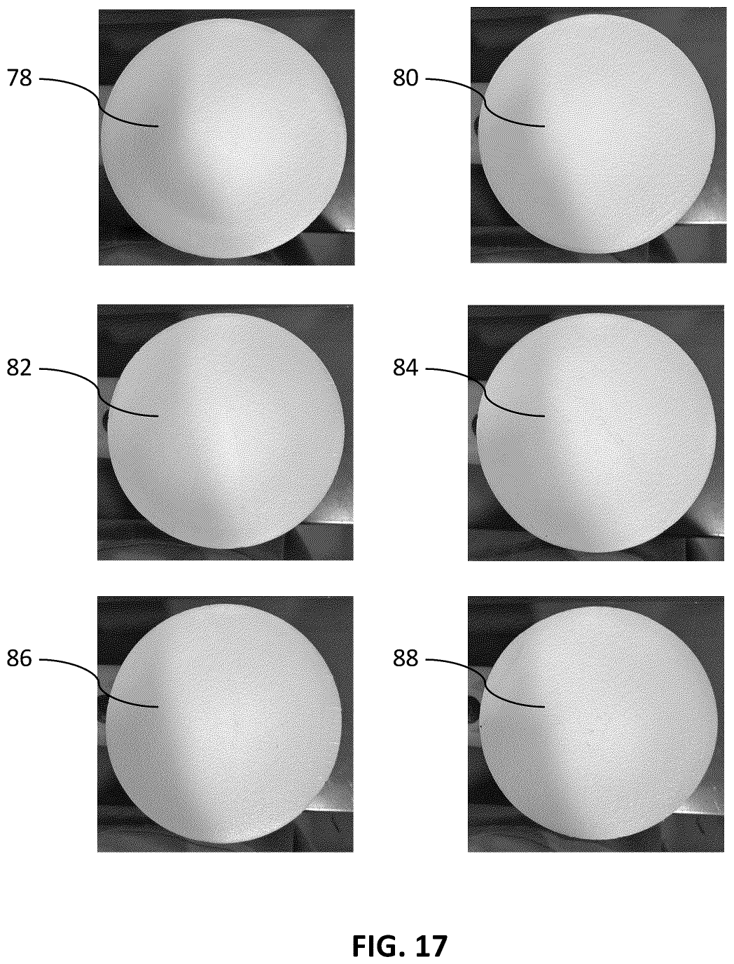

The images of FIGS. 16 and 17 depict cross-sectional views of articles 66, 68, 70, 72, 74, 76, 78, 80, 82, 84, 86, and 88 with TPU formulations and molding conditions adjusted to achieve desirable article flexibilities. The articles 66, 68, 70, 72, 74, 76, 78, 80, 82, 84, 86, and 88 were all prepared based on the molding conditions of temperatures of 60° C. at the feed-throat, 200° C. at zone 4, 200° C. at zone 3, 210° C. at zone 2, 215.6° C. at zone 1, 221.1° C. at nozzle 2, and 221.1° C. at nozzle 1, and the injection velocity is 1 in³/sec.

Article 66 is prepared with a shot size of 22 in³ and cooling time of 300 seconds. The article 66 exhibits excellent surface finish qualities and a uniform cellular structure. However, there are signs of inconsistently flat indicating dimensional instability. The density reduction is 23% (reduction as compared to the density of a “solid” TPU made without blowing and nucleating agents).

Article 68 is prepared with a shot size of 22 in³ and cooling time of 300 seconds. The article 68 exhibits excellent surface finish qualities and a uniform cellular structure. However, there are signs of inconsistently flat indicating dimensional instability. The density reduction is 27%.

Article 70 is prepared with a shot size of 22 in³ and cooling time of 300 seconds. The article 70 exhibits excellent surface finish qualities and a uniform cellular structure. However, there are signs of inconsistently flat indicating dimensional instability. The density reduction is 27%.

Article 72 is prepared with a shot size of 22 in³ and cooling time of 300 seconds. The article 72 exhibits excellent surface finish qualities and a uniform cellular structure. However, there are signs of inconsistently flat indicating dimensional instability. The density reduction is 27%.

Article 74 is prepared with a shot size of 24 in³ and cooling time of 300 seconds. The article 74 exhibits excellent surface finish qualities and a uniform cellular structure. However, the article 74 may be too dense to achieve a flat part without flash. The density reduction is 16%.

Article 76 is prepared with a shot size of 24 in³ and cooling time of 300 seconds. The article 76 exhibits excellent surface finish qualities and a uniform cellular structure. However, the article 76 is inconsistently flat. The density reduction is 15%.

Article 78 is prepared with a shot size of 23.5 in³ and cooling time of 300 seconds. The article 76 exhibits excellent surface finish qualities and a uniform cellular structure. However, the article 76 is inconsistently flat. The density reduction is 18%.

Article 80 is prepared with a shot size of 23 in³ and cooling time of 300 seconds. The article 76 exhibits excellent surface finish qualities and a uniform cellular structure. However, the article 76 is inconsistently flat. The density reduction is 19%.

Article 82 is prepared with a shot size of 22.75 in³ and cooling time of 300 seconds. The article 76 exhibits excellent surface finish qualities and a uniform cellular structure. However, the article 76 is inconsistently flat. The density reduction is 21%.

Article 84 is prepared with a shot size of 22.25 in³ and cooling time of 300 seconds. The article 76 exhibits excellent surface finish qualities and a uniform cellular structure. However, the article 76 is inconsistently flat. The density reduction is 23%.

Article 86 is prepared with a shot size of 22.25 in³ and cooling time of 300 seconds. The article 76 exhibits excellent surface finish qualities and a uniform cellular structure. However, the article 76 is inconsistently flat. The density reduction is 23%.

Article 88 is prepared with a shot size of 19 in³ and cooling time of 300 seconds. The article 76 exhibits excellent surface finish qualities and a uniform cellular structure. However, the article 76 is inconsistently flat. The density reduction is 36%.

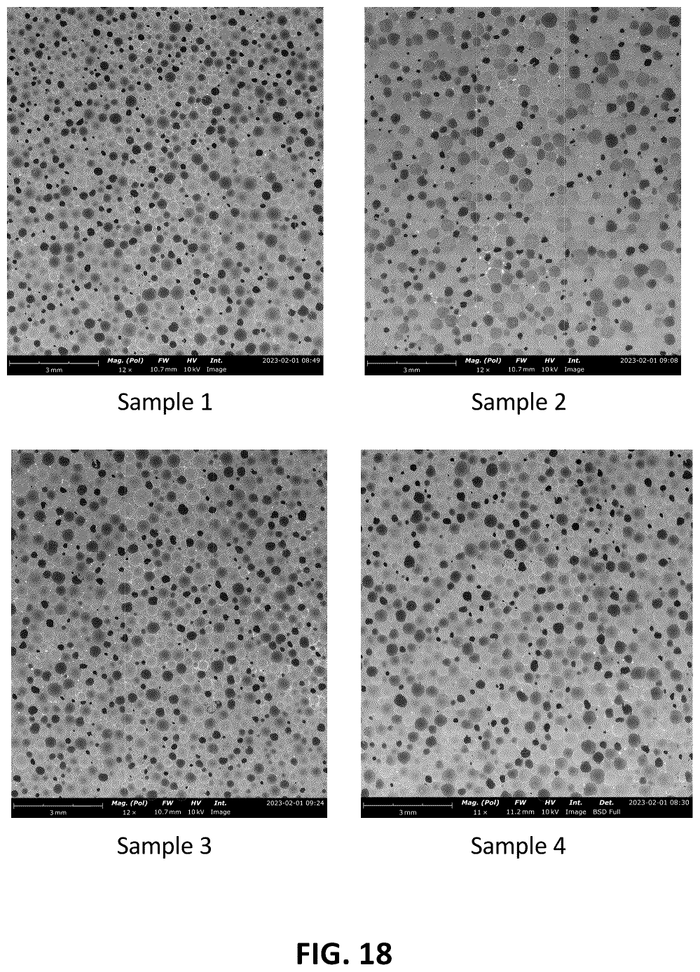

FIGS. 18-20 are scanning electron microscope (SEM) images of articles (labeled samples 1-10) formed from TPU formulations that include blowing agent between about 0.01 wt. % and about 2.5 wt. % and the nucleating agent between about 0.01 wt. % and 2 wt. %. The amounts of blowing agent and nucleating agent in particular, are adjusted to control the foam flexibility through controlling the morphology.

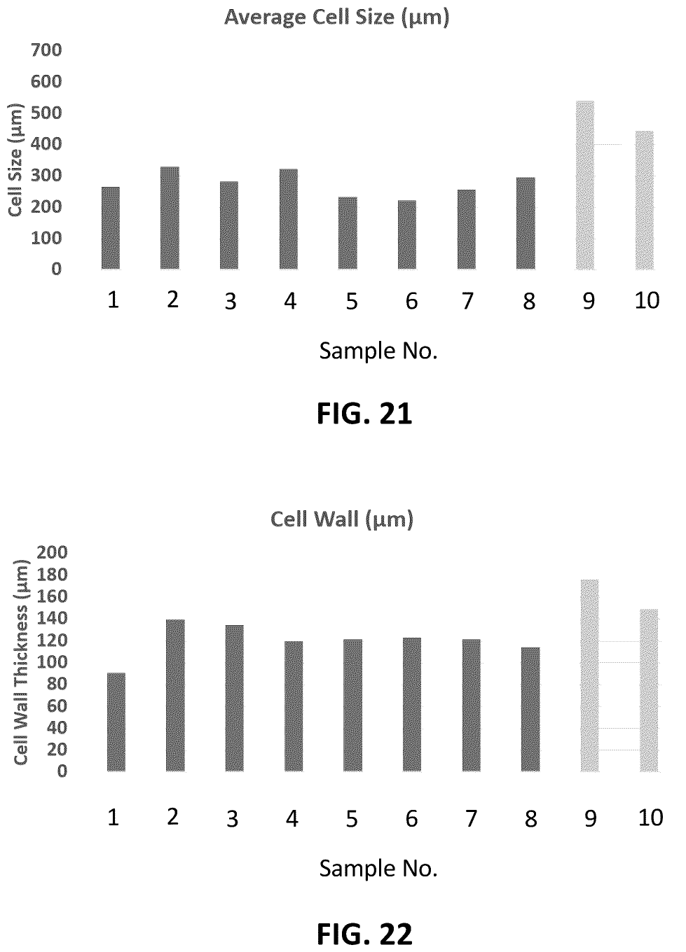

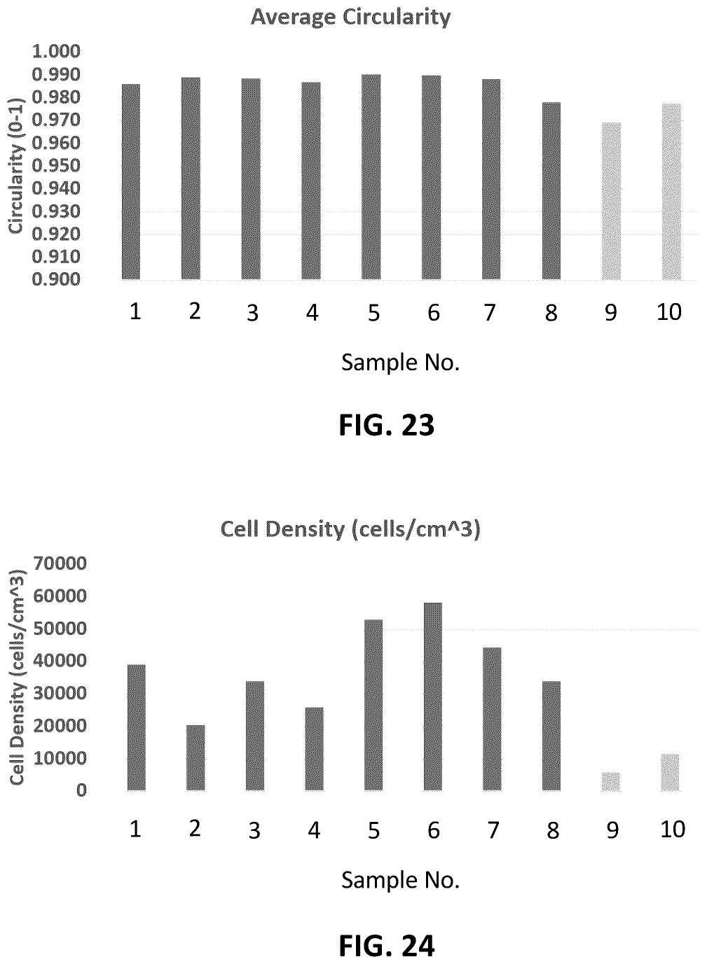

FIGS. 21-24 are charts showing results of applying image analysis techniques to analyze the morphology of Samples 1-10 quantitatively in terms of the average cell size (μm), average cell wall thickness (μm), average circularity, and cell density (cells/cm³), respectively. For FIG. 21, the average cell size is shown in terms of a single diameter. Because the circularity is very high (see FIG. 23, circularity is between 0.97 and 0.99), a single diameter can be used in place of a long axis (A_{L}) and a short axis (A_{S}).

Based on results illustrated in FIGS. 6-24, it is demonstrated that by changing the TPU formulations and the mold injection conditions, the cell nucleation and growth can be controlled to make articles with different weight reductions and to achieve structural uniformity. For example, by changing the formulation and/or the molding conditions, more than 15% density reduction can be achieved. For example, by changing the formulation and/or the molding conditions, cellular structures of average cell size less than 900 micrometer (μm) can be achieved. For example, by changing the formulation and/or the molding conditions, cellular structures of average cell wall thickness greater than 10 μm can be achieved. For example, by changing the formulation and/or the molding conditions, cellular structures of average cell density of more than 1000 cells/cubic centimeter (cells/cm³) can be achieved.

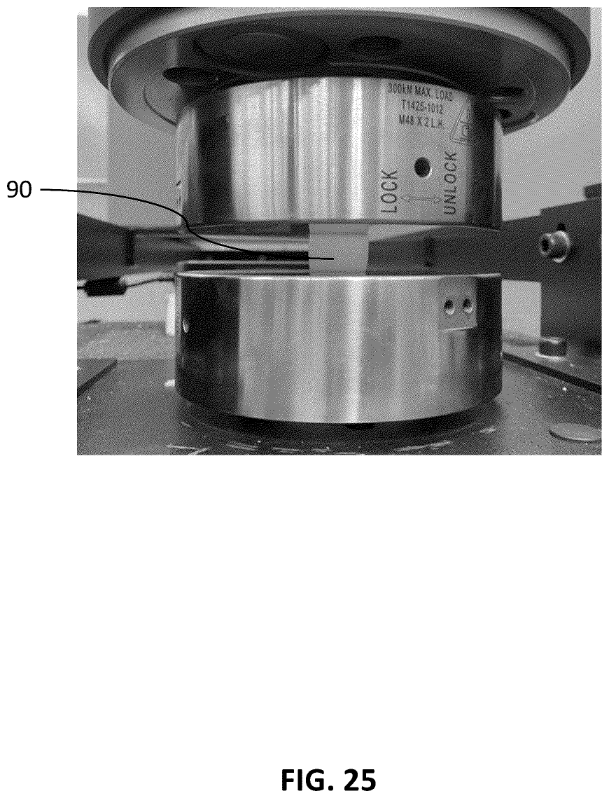

In this disclosure, uniaxial compression tests are conducted to quantitatively characterize the flexibility and performance of the TPU foam articles using an Instron model 5985. Cuboid samples of 1×1×1 inch are cut out of molded TPU foam articles. FIG. 25 is an image of an example TPU foam article 90 undergoing a compression test. The testing procedure is as follow: (1) Preload: The sample is compressed in displacement mode at a rate of 10 millimeter per minute (mm/min) until 40 Newton (N) of force is achieved, this step is to ensure that the movable side of the testing machine is touching the sample properly prior to the actual test; (2) Ramp Step: Compressing the sample in displacement mode at a rate of 0.5 mm/min until 50% compressive strain is achieved; (3) Hold Step: Holding the sample at 50% compressive strain for a period of 60 seconds; (4) Ramp Step: Uncompressing the sample in displacement mode at a rate of 0.5 mm/min until 0% compressive strain is achieved; and (5) Repeating step (2) to (4) to complete 6 cycles.

The test is performed on 3 to 5 samples from the same batch (e.g., TPU foam articles made of the same formulations and molding conditions) to ensure the consistency of the results. The samples are cut horizontally (e.g., along the X-Y plane of the cuboid sample) and vertically (e.g., along the X-Z plane or the Y-Z plane of the cuboid sample) before and after the compression test (24 hours after the same is removed from the stressed condition), and a full morphological analysis and measurements (e.g., the average cell size, cell wall thickness, and cell density) are performed on these samples to evaluate the effects of the cyclic deformations on the morphologies of the samples.

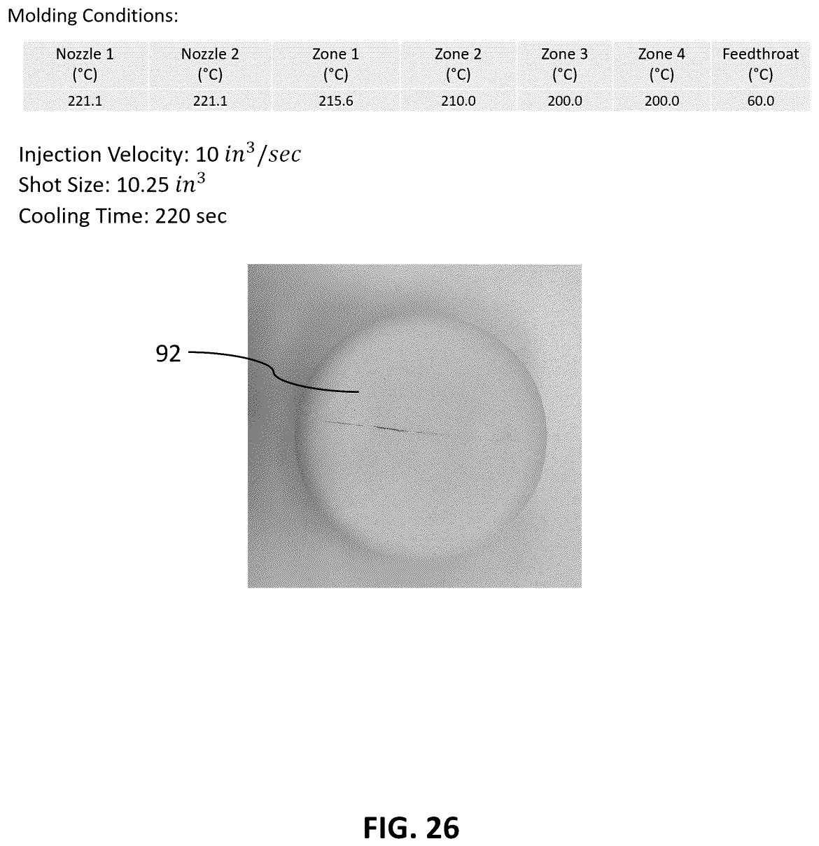

FIGS. 26-34 illustrate images and results of testing for TPU foam articles, labeled parts A, B, and C that are formed from the molding conditions shown in FIG. 26. An image of the cross-section of an article 92 is from one of the parts A, B, and C. Parts A, B, and C consistently exhibit a uniform cellular structure, excellent surface finish, and a density reduction of 34% (relatively low density).

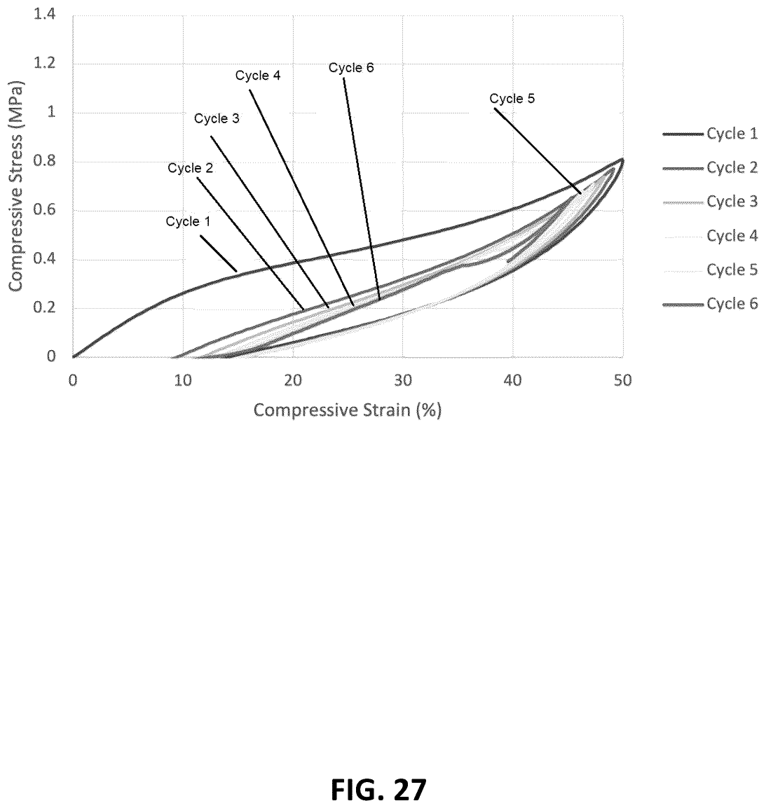

FIG. 27 shows averaged 6-cycle compressive stress-strain curves of the cuboid samples from parts A, B, and C. By changing the formulation and/or the molding conditions, a compressive stress less than 1.5 megapascal (MPa) at a compressive strain of about 50% can be achieved. In the first cycle, at 50% compressive strain, the average compressive stress is about 0.8 Mega Pascal (MPa). The hysteresis loss due to plastic deformation in the second cycle through the sixth cycle is acceptably insignificant.

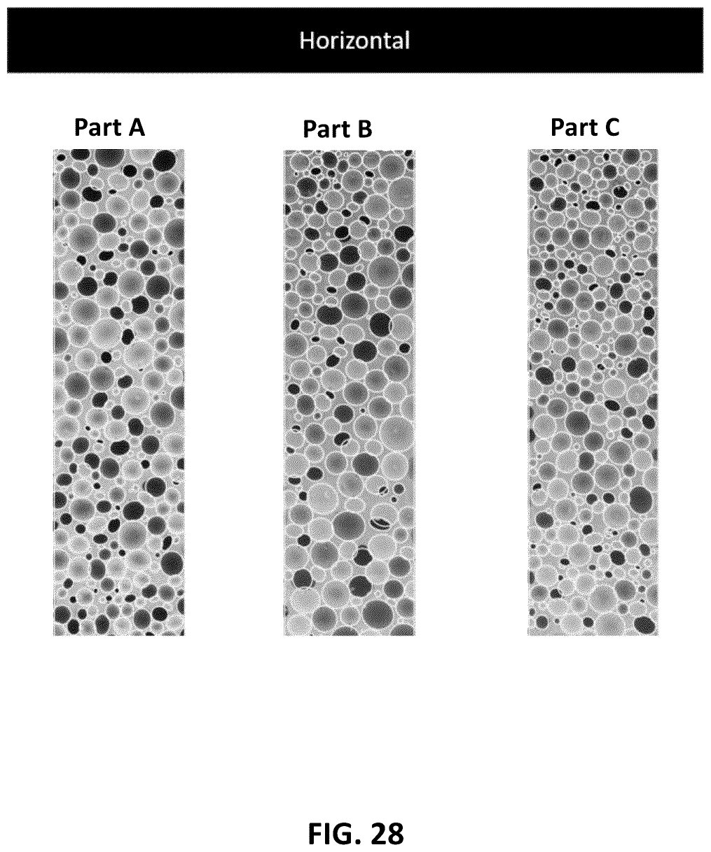

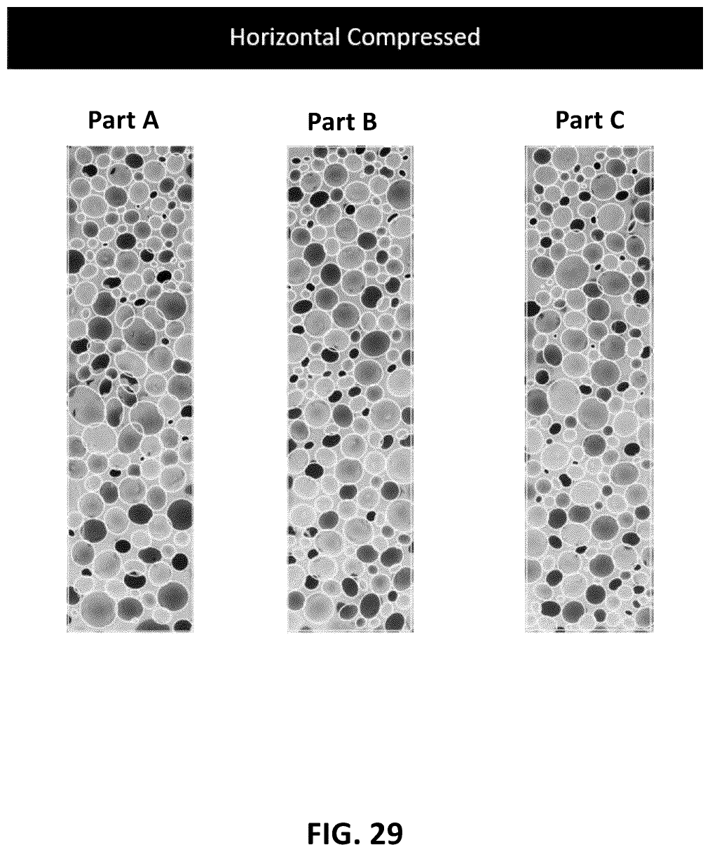

FIG. 28 shows example SEM images of horizontal cuts of the cuboid samples from parts A, B, and C before the compression test. For comparison, FIG. 29 shows example SEM images of horizontal cuts of the cuboid samples from parts A, B, and C 24 hours after the compression test.

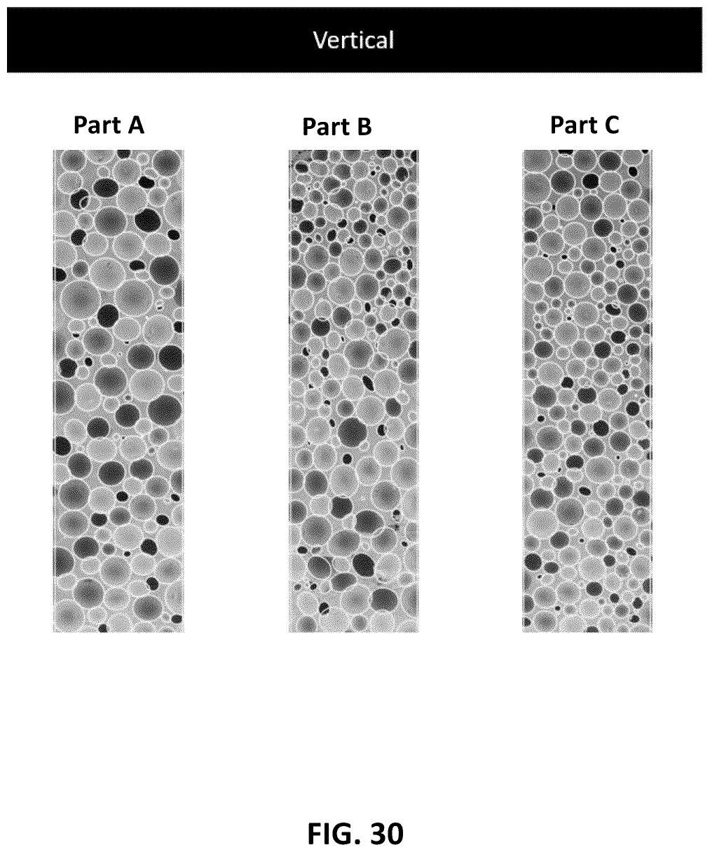

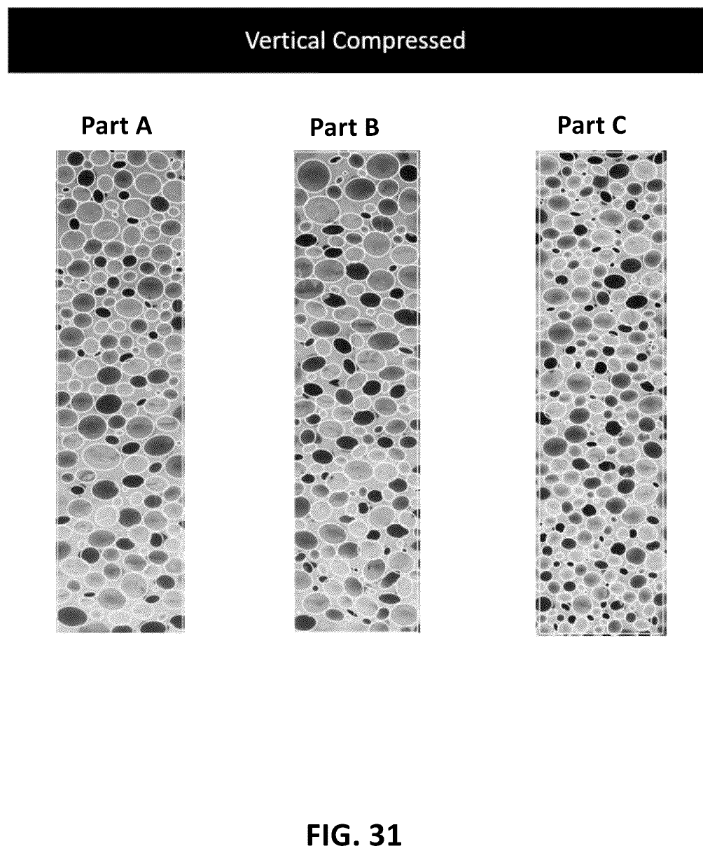

FIG. 30 shows example SEM images of vertical cuts of the cuboid samples from parts A, B, and C before the compression test. For comparison, FIG. 31 shows example SEM images of vertical cuts of the cuboid samples from Parts A, B, and C 24 hours after the compression test.

When the cellular outlines of the uncompressed samples illustrated in FIGS. 28 and 30 are overlayed on the cellular outlines of the compressed samples illustrated in in FIGS. 29 and 31, based on such an overlay analysis, it appears that these cellular structures exhibit excellent recovery/shape memory quality that upon removal of the stress, the foams recover close to its original structure. Such shape memory/recovering ability is also seen in results of the quantitative cellular structure analysis below.

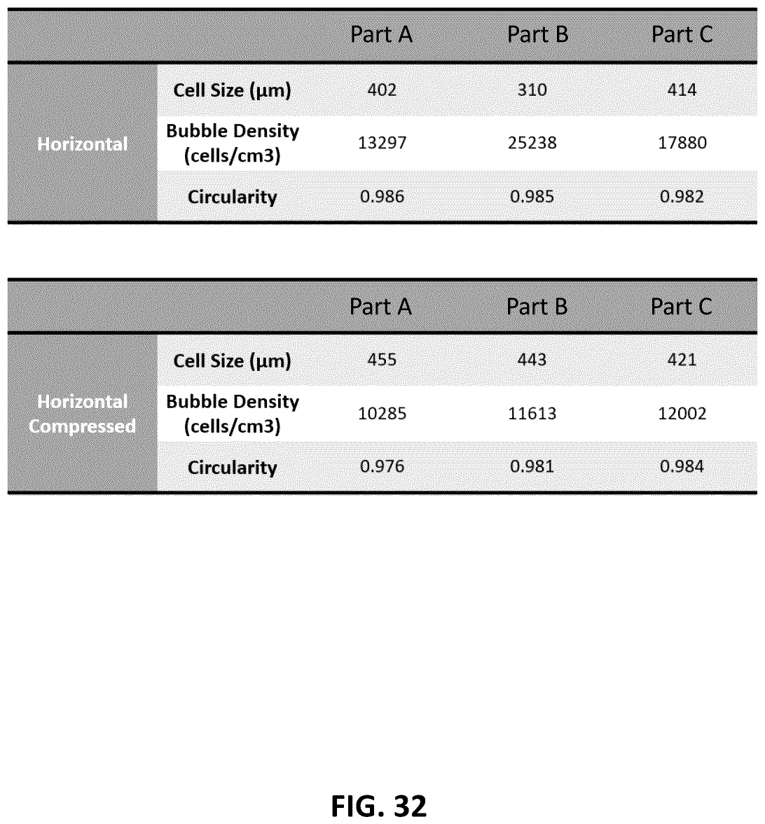

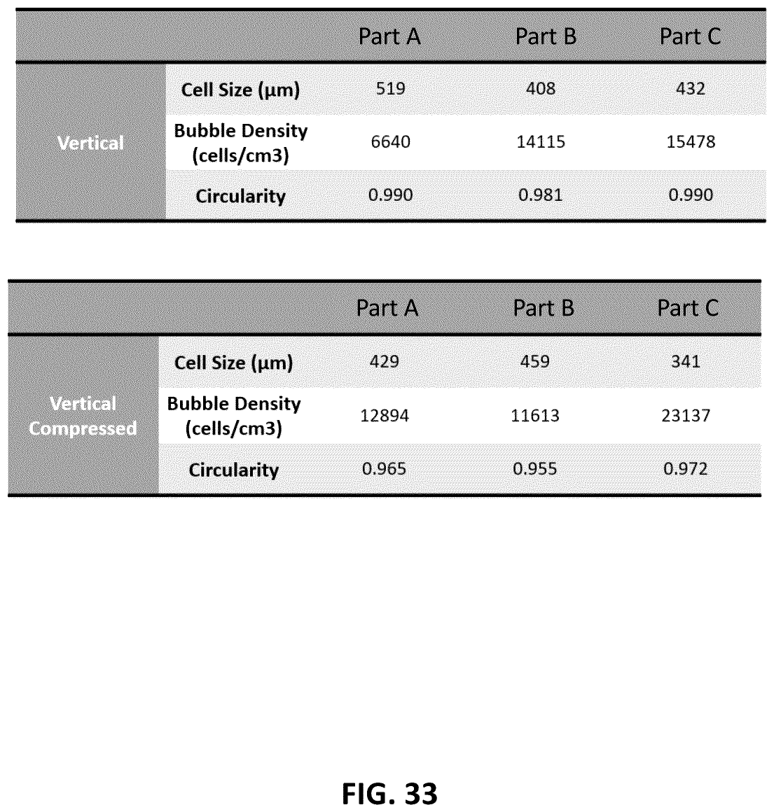

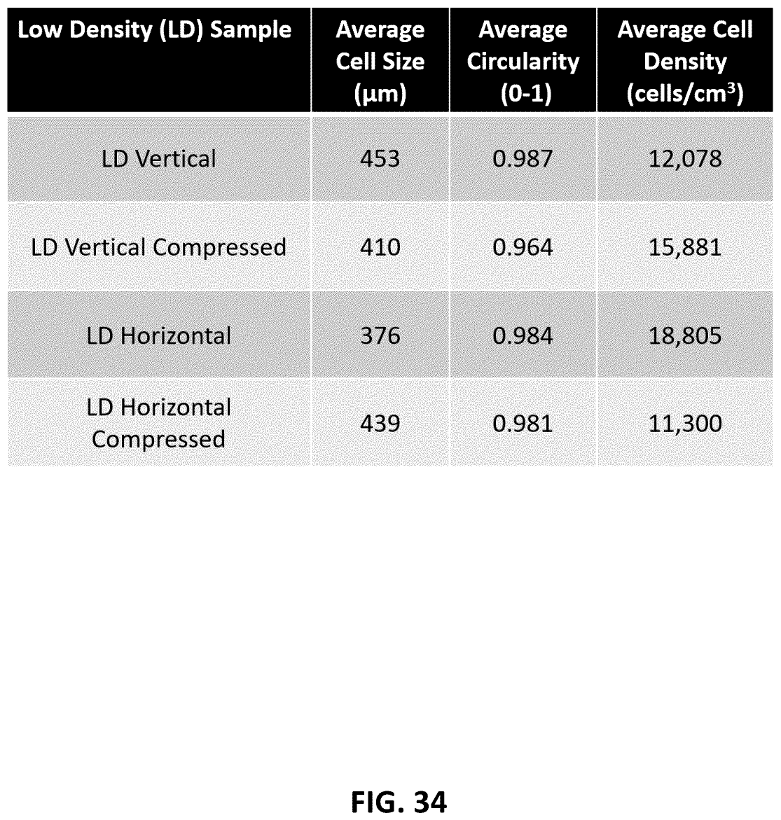

Image analysis techniques are applied to analyze the morphology of the SEM images shown in FIGS. 28-31, and the cell size (μm), cell density (cells/cm³), and circularity of the horizontal and vertical cuts of the cuboid samples form parts A, B, and C, before and after the compression test are summarized in FIGS. 32 and 33, respectively. The averaged cell size (μm), cell density (cells/cm³), and circularity of the horizontal and vertical cuts of the cuboid samples form parts A, B, and C, before and after the compression test are summarized in FIG. 34. The cell size, cell density, and circularity values of the compressed samples after 24 hours of recovery, do not deviate significantly from the original values.

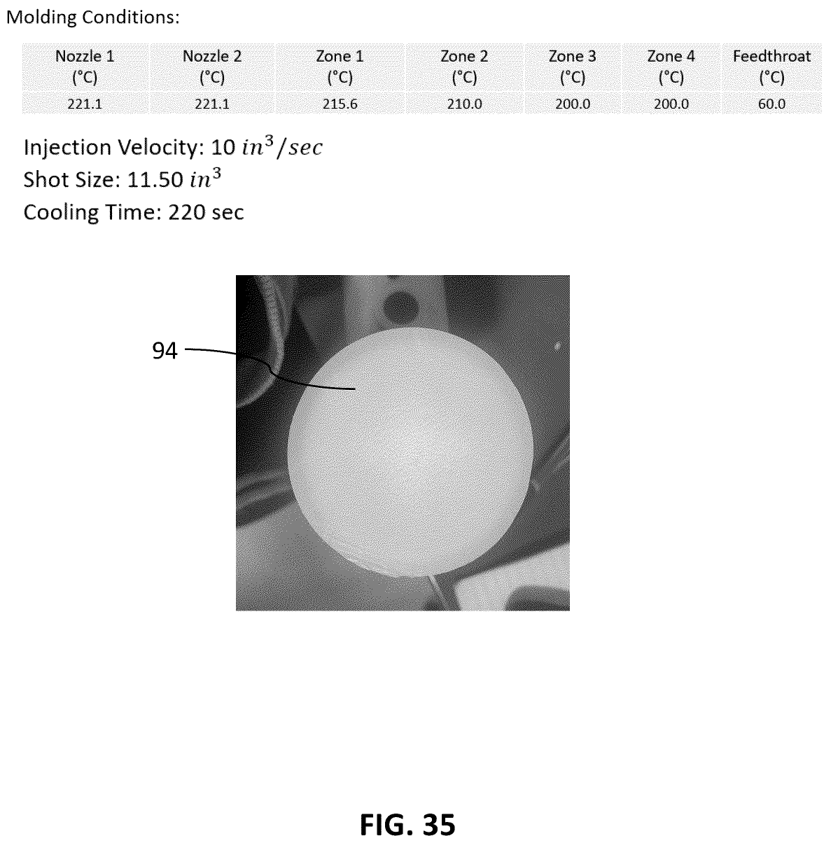

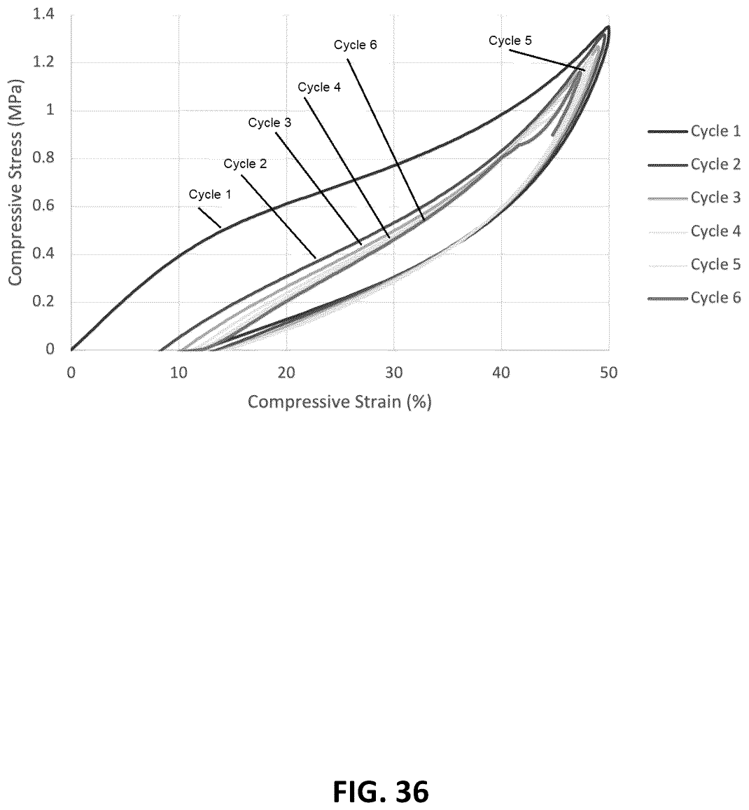

FIGS. 35-43 illustrate images and results of testing for TPU foam articles, labeled parts D, E, and F that are formed from the molding conditions shown in FIG. 35. An image of a cross-section 94 is from one of the parts D, E, and F. Parts D, E, and F consistently exhibit a uniform cellular structure, excellent surface finish, and a density reduction of 24% (relatively high density).

FIG. 36 shows averaged 6-cycle compressive stress-strain curves of the cuboid samples from parts D, E, and F. By changing the formulation and/or the molding conditions, a compressive stress less than 1.5 megapascal (MPa) at a compressive strain of about 50% can be achieved. In the first cycle, at 50% compressive strain, the average compressive stress is about 1.35 Mega Pascal (MPa). The hysteresis loss due to plastic deformation in the second cycle through the sixth cycle is acceptably insignificant.

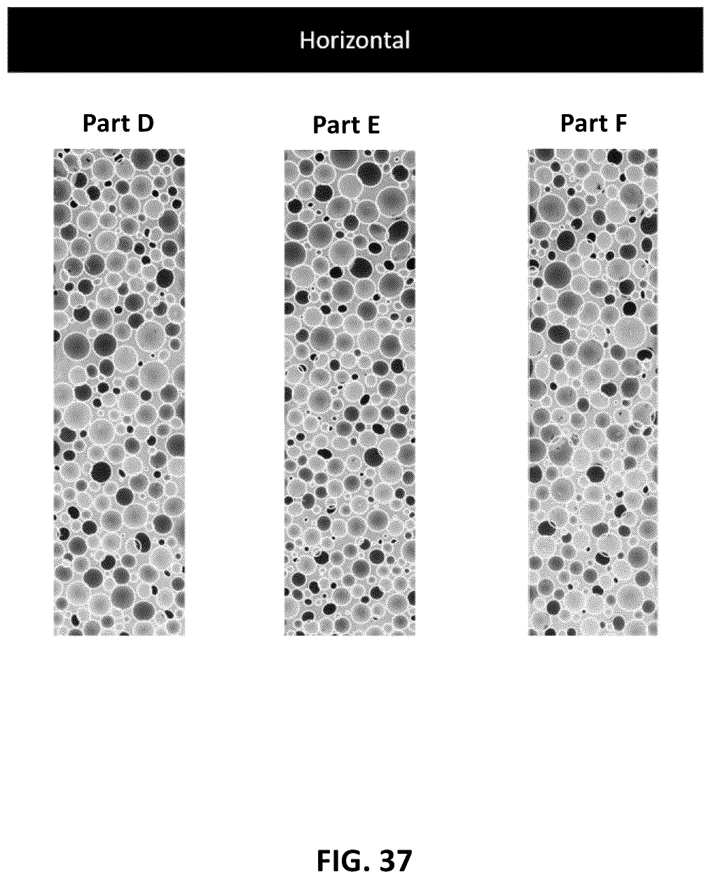

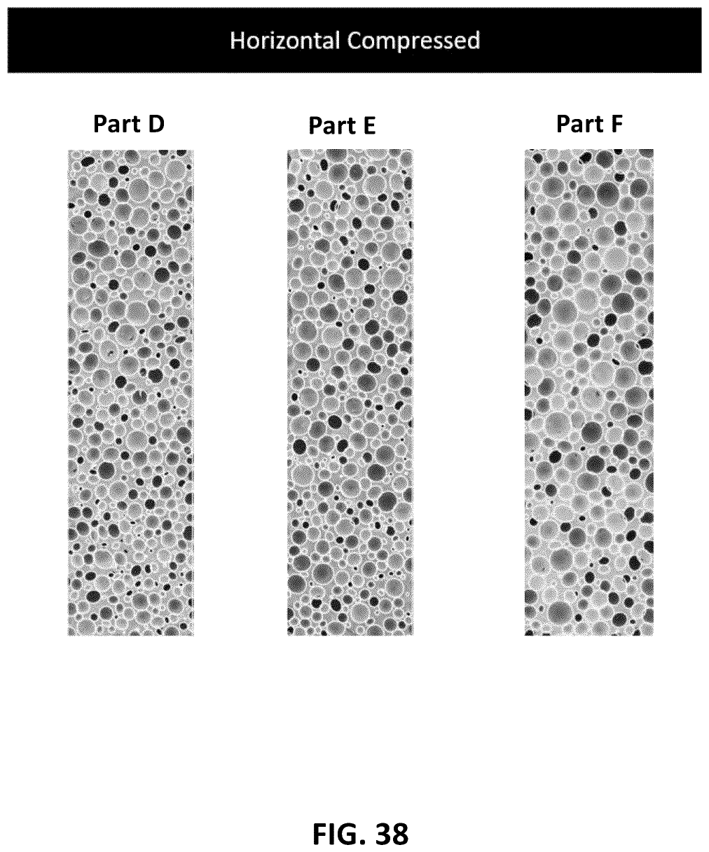

FIG. 37 shows example SEM images of horizontal cuts of the cuboid samples from parts D, E, and F before the compression test. For comparison, FIG. 38 shows example SEM images of horizontal cuts of the cuboid samples from Parts D, E, and F 24 hours after the compression test.

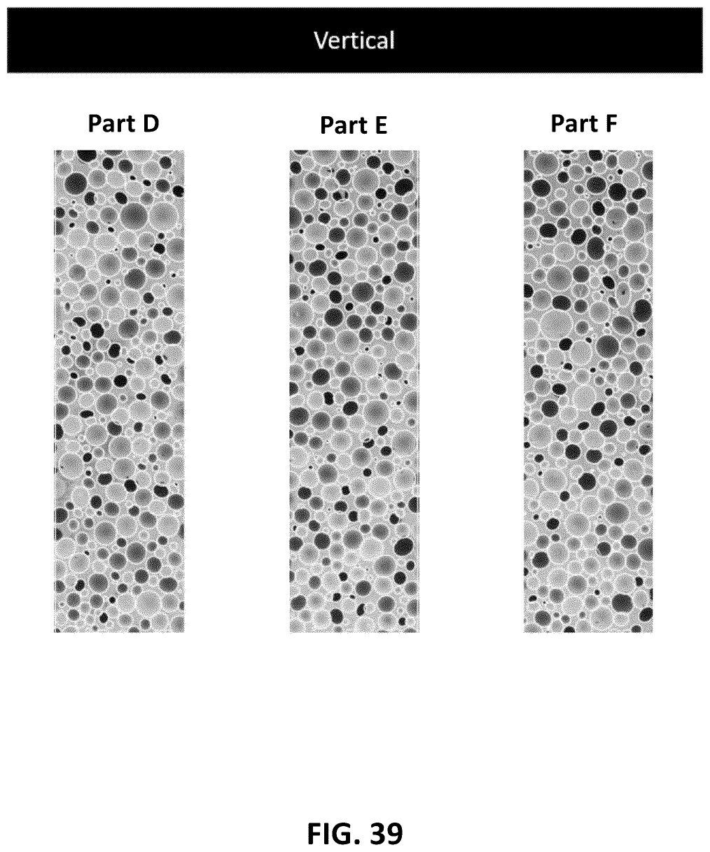

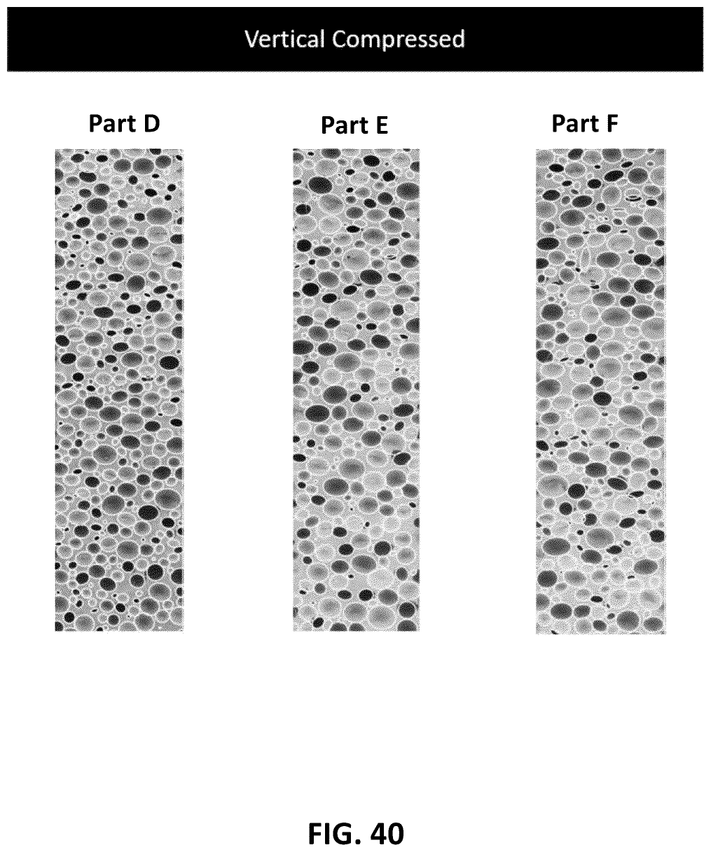

FIG. 39 shows example SEM images of vertical cuts of the cuboid samples from parts D, E, and F before the compression test. For comparison, FIG. 40 shows example SEM images of vertical cuts of the cuboid samples from parts D, E, and F 24 hours after the compression test.

When the cellular outlines of the uncompressed samples illustrated in FIGS. 37 and 39 are overlayed on the cellular outlines of the compressed samples illustrated in in FIGS. 38 and 40, based on the overlay analysis, it appears that the cellular structure exhibits excellent recovery/shape memory quality that upon removal of the stress, the foam recovers close to its original structure. Such shape memory/recovering ability is also seen in results of the quantitative cellular structure analysis below.

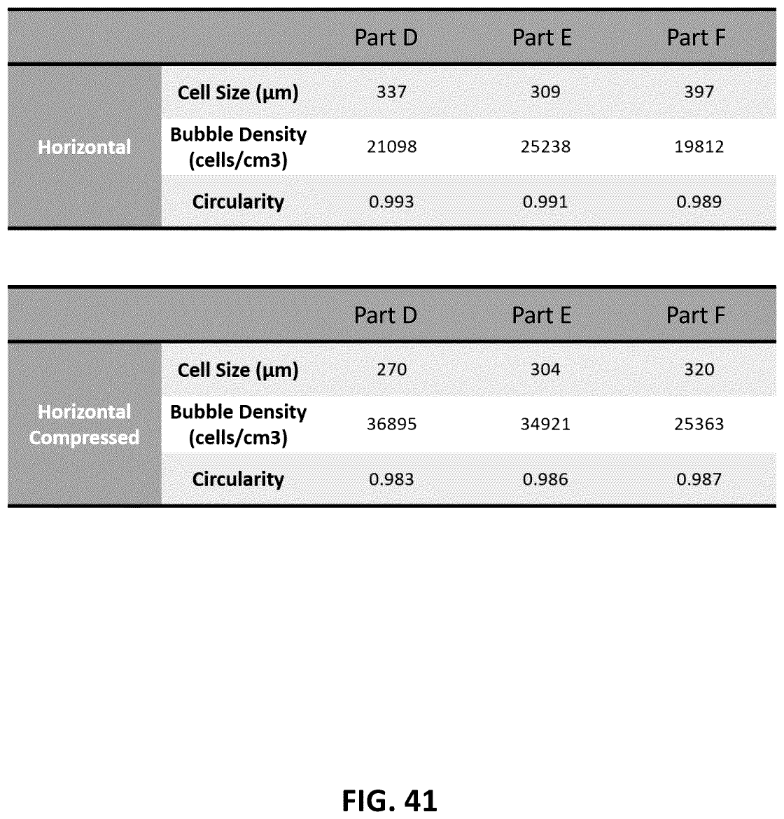

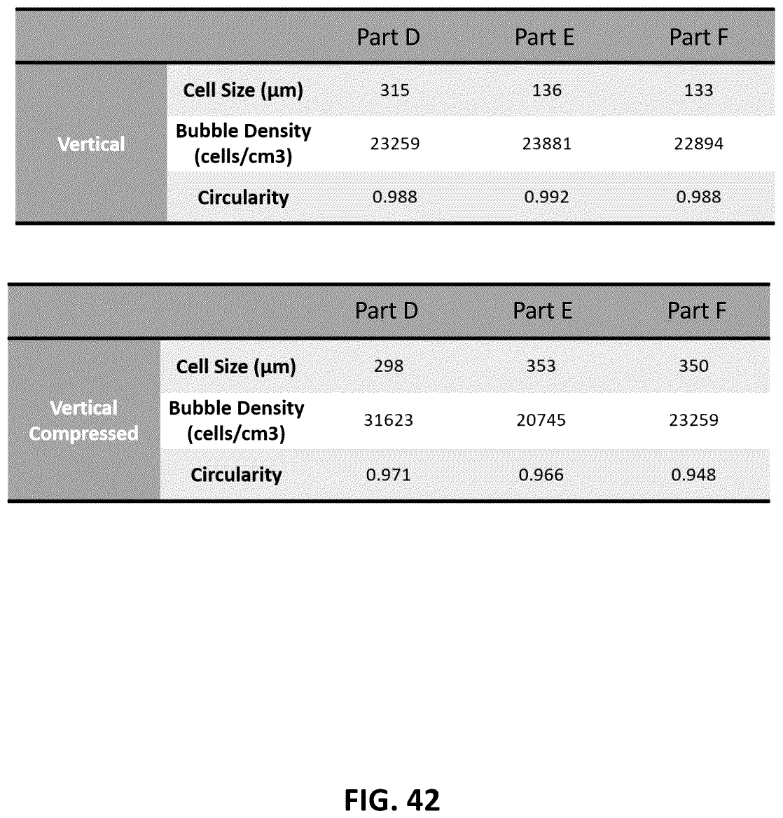

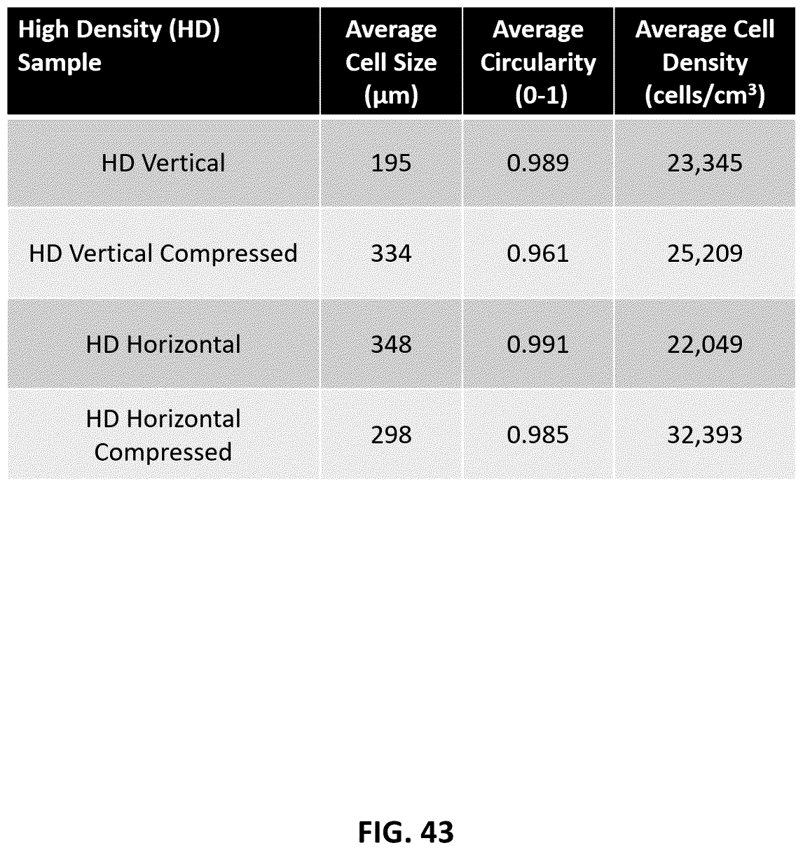

Image analysis techniques are applied to analyze the morphology of the SEM images shown in FIGS. 37-40, and the cell size (μm), cell density (cells/cm³), and circularity of the horizontal and vertical cuts of the cuboid samples form parts D, E, and F, before and after the compression test are summarized in FIGS. 41 and 42, respectively. The averaged cell size (μm), cell density (cells/cm³), and circularity of the horizontal and vertical cuts of the cuboid samples form parts D, E, and F, before and after the compression test are summarized in FIG. 43.

The cell size, cell density, and circularity values of the compressed samples after 24 hours of recovery, do not deviate significantly from the original values.

The foregoing description of examples has been presented for purposes of illustration and description. It is not intended to be exhaustive or limiting to the forms described. Numerous modifications are possible in light of the above teachings. Some of those modifications have been discussed, and others will be understood by those skilled in the art. The examples were chosen and described in order to best illustrate principles of various examples as are suited to particular uses contemplated. The scope is, of course, not limited to the examples set forth herein, but can be employed in any number of applications and equivalent devices by those of ordinary skill in the art.

We claim:

1. A method of forming a foamed article, the method comprising:
providing a thermoplastic polymer;
adding the thermoplastic polymer, a blowing agent in an amount from 0.01 wt % to about 5 wt %, and a nucleating agent in an amount from about 0.01 wt % to about 4.0 wt % to a melt zone of an injection molding machine to form a mixture,
melting the mixture within the melt zone of the injection molding machine;
injecting the mixture into a mold cavity;
cooling the mold cavity;
and removing the article from the mold cavity,
wherein the cellular structure of the foamed article has structural uniformity in cell size and cell density throughout the entire article.

2. The method of claim 1, wherein the thermoplastic polymer is selected from thermoplastic polyurethane, thermoplastic elastomer, thermoplastic vulcanizates, or a blend thereof.

3. The method of claim 1, wherein the injection molding machine further comprises at least one hopper that provides storage of the thermoplastic polymer, blowing agent, and/or nucleating agent and arranged to selectively deliver the thermoplastic polymer, blowing agent, and/or nucleating agent to the melt zone of the injection molding machine.

4. The method of claim 1, wherein the thermoplastic polymer, blowing agent, and/or nucleating agent are delivered to the melt zone of the injection molding machine at the same time and mixed in the melt zone until the mixture reaches a homogeneous state.

5. The method of claim 1, wherein the mixture is heated within the injection molding machine to a temperature between about 190° C. and 245° C.

6. The method of claim 1, wherein the mixture further comprises an additive.

7. The method of claim 1, wherein the cellular structure of the formed article is structurally uniform from one exterior surface to another exterior surface.

8. The method of claim 1, wherein the cellular structure of the formed article is structurally uniform with respect to cell wall thickness.

9. The method of claim 1, wherein the cell size of the foamed article is less than 900 μm.

10. The method of claim 6, wherein the cell size of the foamed article is between 200 μm and 600 μm.

11. The method of claim 1, wherein the cell density of the foamed article is more than 1000 cells/cubic centimeters.

12. The method of claim 8, wherein the cell density of the foamed article is between 1000 cells/cubic centimeters and 60,000 cells/cubic centimeters.

13. The method of claim 1, wherein article is characterized by consistent reaction over multiple cycles of compressive stress.

14. A thermoplastic polymer foamed article, comprising a mixture of:
a thermoplastic polymer;
a blowing agent in an amount from 0.01 wt % to about 2.5 wt %; and
a nucleating agent in an amount from about 0.01 wt % to about 2.0 wt %;
wherein the molding conditions of the thermoplastic foamed article comprise an injection temperature of between 190° C. and 245° C.; and
wherein the thermoplastic foamed article formed by this process is characterized by structural uniformity in cell size and cell density throughout the entire article.

15. The article of claim 14, wherein the cell size of the foamed article is between 200 μm and 600 μm.

16. The article of claim 14, wherein the cell density of the foamed article is between 1000 cells/cubic centimeters and 60,000 cells/cubic centimeters.

17. The article of claim 14, wherein the circularity of 75 percent of the cells are within the range of 0.900 to 1.00.

18. The article of claim 14, wherein article is characterized by compressive stress of less than 1.5 megapascal.

19. The article of claim 4 wherein article is characterized by consistent reaction over multiple cycles of compressive stress.

20. The article of claim 14, wherein the mixture further comprises an additive.
